(19) United States
(12) Patent Application Publication
(10) Pub. No.: US 2019/0097404 A1
(43) Pub. Date: Mar. 28, 2019

(54) JUNCTION BOX

(71) Applicant: QTran, Inc., Milford, CT (US)

(72) Inventors: John TREMAINE, New Canaan, CT (US); Adrian TESCHEMAKER, West Haven, CT (US)

(21) Appl. No.: 16/082,694

(22) PCT Filed: Mar. 6, 2017
(86) PCT No.: PCT/US2017/020870

§ 371 Date: Sep. 6, 2018

Related U.S. Application Data
(60) Provisional application No. 62/416,891, filed on Nov. 3, 2016.
(60) Provisional application No. 62/304,273, filed on Mar. 6, 2016.

(51) Int. Cl. H02G 3/08; H02G 3/10; H02G 3/14; H02G 3/18; H02G 3/12; H02G 3/16

(52) U.S. Cl. CPC H02G 3/088; H02G 3/10; H02G 3/14; H02G 3/16; H02G 3/085; H02G 3/123; H02G 3/185

(57) ABSTRACT

A junction box that includes a housing at least partially enclosing an interior region of the junction box and having a perimeter extending around the interior region, a perimeter flange extending at least partially around the perimeter of the housing, a housing cover configured for removable attachment to the housing at the perimeter flange, and at least one device mounting post positioned within the interior region. The present invention more particularly relates to a junction box that is configured to be rendered as a rain-tight assembly even when conductors and/or units are connected to the junction box and prior to final installation and/or use of the junction box. The present invention also particularly relates to a junction box that may also be configured to surface wall or ceiling and/or floor mounting and/or floor installation, and is further configured for multiple uses.

### CROSS-REFERENCE TO RELATED APPLICATIONS

This application claims priority to U.S. Provisional Appl. Nos. 62/304,273 filed Mar. 6, 2016 and 62/416,891 filed Nov. 3, 2016, both of which are hereby incorporated by reference herein in their entireties.

### BACKGROUND OF THE INVENTION

### 1. Field of the Invention

The present invention generally relates to a junction box, and more particularly relates to a junction box that is configured to be rendered as a rain-tight assembly even when conductors and/or units are connected to the junction box and prior to final installation and/or use of the junction box.

The present invention also particularly relates to a junction box that may also be configured to surface wall or ceiling and/or floor mounting and/or floor installation, may include an internal backing plate for strengthening and grounding, may further include a snap-in trim frame for bordering the junction box to provide a finished look when the junction box is installed, and is further configured for multiple uses, such as, but not limited to electrical outlets, ports and/or connectors for low voltage data, dimmers/switches, LED drivers, power supplies, wall sconces and other electrical components.

### SUMMARY OF THE INVENTION

The present invention is designed to overcome the above noted limitations that are attendant upon the use of conventional junction boxes and, toward this end, it contemplates the provision of a novel junction box.

It is an object of the present invention to provide a junction box that is configured to be rain-tight even with conductors and/or units installed prior to final installation and/or use of the junction box.

It is another object of the present invention to provide a junction box that can be exposed to driving rain and remain substantially rain-tight when electrical conducts and/or units have been connected to the junction box as a listed wiring assembly, e.g. NRTL, prior to final installation and/or use of the junction box in a dry location.

It is still another object of the present invention to provide a junction box that is configured and appropriate for wall mounted applications.

It is another object of the present invention to provide a junction box that is suitable for housing and/or containing a variety of electrical components, such as electrical outlets, ports and/or connectors for low voltage data, dimmers/switches, LED drivers, power supplies and the like.

It is yet another object of the present invention to provide a junction box that is configured to receive a snap-in frame in order to provide a finished look for the junction box.

It is still another object of the present invention to provide a junction box that is configured to receive a barrier plate that can be used to separate portions of the junction box so different classes of wiring can be installed in same the junction box.

It is yet another object of the present invention to provide a junction box made from a non-conductive material, such as plastic or fiberglass, that is configured to ground metal cable or conduit connected to the junction box.

It is still another object of the present invention to provide a junction box that is capable of being integrated into a pre-fabricated wall assembly so that the entire wall assembly is capable of obtaining desired UL and/or NRTL listings.

It is yet another object of the present invention to provide a junction box that is configured to serve as a base housing and/or a support structure for a wall sconce.

It has now been found that the foregoing and related objects can be readily attained in the exemplary embodiments of the junction box that are shown and described in the present application.

In accordance with an exemplary embodiment of the present invention junction box is provided that may include a housing at least partially enclosing an interior region of the junction box and having a perimeter extending around the interior region, a perimeter flange extending at least partially around the perimeter of the housing, a housing cover configured for removable attachment to the housing at the perimeter flange, and at least one device mounting post positioned within the interior region.

According to this or other exemplary embodiments of the present invention, the housing cover may include at least one opening providing access to the interior region of the junction box.

According to this or other exemplary embodiments of the present invention, the device mounting post may be configured to provide support and retention of at least one electrical device, and the opening may be substantially aligned with the device mounting post to allow the at least one electrical device to be positioned at least partially within the opening.

According to this or other exemplary embodiments of the present invention, the device mounting post may be configured for removable attachment to the interior region of the junction box.

According to this or other exemplary embodiments of the present invention, the device mounting post may include a base portion configured for press-fit attachment to the housing and a terminal block receptacle configured for receipt and retention of a terminal block.

According to this or other exemplary embodiments of the present invention, the device mounting post may include a base portion and a pair of stanchions extending from the base portion and configured for receipt of an electrical device.

According to this or other exemplary embodiments of the present invention, the junction box further may include a sealing gasket positioned between the housing cover and the perimeter flange.

According to this or other exemplary embodiments of the present invention, the junction box further may include a peripheral flange extending at least partially around the perimeter flange, and the peripheral flange may include a perimeter channel configured to receive a peripheral gasket.

According to this or other exemplary embodiments of the present invention, the peripheral flange may be configured for connection to a removable cover, and the peripheral gasket may be configured for positioning between the peripheral flange and the removable cover.

According to this or other exemplary embodiments of the present invention, the junction box may also include at least one mounting tab positioned on an exterior surface of the housing.

According to this or other exemplary embodiments of the present invention, each of the at least one mounting tabs may include an alignment notch.

According to this or other exemplary embodiments of the present invention, the junction box may also include a wire connecting post positioned within the interior region of the junction box and configured for connection to at least one electrical wire.

According to this or other exemplary embodiments of the present invention, the junction box may also include a divider plate positioned within the interior region of the junction box and configured to divide the interior region of the junction box into at least two separate sections.

According to this or other exemplary embodiments of the present invention, the junction box may also include a grounding plate having at least one thru-hole and positioned within the interior region of the junction box, and at least one knock-out positioned in the housing and substantially aligned with the thru-hole of the grounding plate.

According to this or other exemplary embodiments of the present invention, the junction box may also include at least one retaining channel positioned within the interior region of the junction box and configured for receipt and retention of at least one wire terminal block.

According to this or other exemplary embodiments of the present invention, the at least two separate sections may include a first section and a second section, and the first section is configured for receipt of a high voltage receptacle and the second section is configured for receipt of a low voltage receptacle.

According to this or other exemplary embodiments of the present invention, the at least one electrical wire is pre-wired to the wire connecting post prior to final installation of the junction box.

### BRIEF DESCRIPTION OF THE SEVERAL VIEWS OF THE DRAWINGS

For a fuller understanding of the nature and object of the present invention, reference should be had to the following detailed description taken in connection with the accompanying drawings, in which:

FIG. 1 is an isometric view of an exemplary rain-tight junction box according to the present invention with a rain-tight cover installed on the junction box;

FIG. 2 is an isometric view of the exemplary junction box according to the present invention without rain-tight cover and snap-in frame;

FIG. 3 is an exploded view of the exemplary junction box according to the present invention;

FIG. 4A is an isometric view of the exemplary junction box according to the present invention with exemplary electronic units installed;

FIG. 4B is a front view of the exemplary junction box according to the present invention with exemplary electronic units installed;

FIG. 5A is an isometric view of the exemplary junction box according to the present invention with an exemplary cover installed;

FIG. 5B is a front view of the exemplary junction box according to the present invention with an exemplary cover installed;

FIG. 6A is an isometric view of the exemplary junction box according to the present invention with an exemplary décor panel installed;

FIG. 6B is a front view of the exemplary junction box according to the present invention with an exemplary décor panel installed;

FIG. 7A is an isometric view of the exemplary junction box according to the present invention with an exemplary frame installed;

FIG. 7B is a front view of the exemplary junction box according to the present invention with an exemplary frame installed;

FIG. 8 is an exploded view of the exemplary junction box according to the present invention;

FIG. 9 is an isometric view of the exemplary junction box according to the present invention installed on a wall surface;

FIG. 10 is an isometric view of another exemplary junction box according to the present invention;

FIG. 10A is an isometric view of an exemplary interchangeable mounting post for use with the exemplary junction box according to the present invention;

FIG. 11 is a front view of the other exemplary junction box according to the present invention;

FIG. 12 is an isometric view of an exemplary grounding plate for use with the exemplary junction box according to the present invention;

FIG. 13 is a front view of an exemplary grounding plate for use with the exemplary junction box according to the present invention;

FIGS. 14-18 are front views of various exemplary cover plate options for use with the exemplary junction boxes according to the present invention;

FIG. 19 is an exemplary electrical installation using the junction boxes according to the present invention;

FIG. 20 is an isometric view of another exemplary junction box according to the present invention;

FIG. 21 is a front view of the other exemplary junction box according to the present invention;

FIG. 22 is a side view of the other exemplary junction box according to the present invention configured for installation in a floor or ceiling;

FIG. 23 is an exemplary electrical installation using the junction boxes according to the present invention;

FIG. 24 is an exploded isometric view of an exemplary water protection boot according to the present invention;

FIG. 25 is an isometric view of the bottom portion of the exemplary water protection boot according to the present invention;

FIG. 26 is an isometric view of the exemplary water protection boot according to the present invention;

FIG. 27 is a cross-sectional view of the exemplary water protection boot according to the present invention;

FIG. 28 is an isometric view of another exemplary junction box according to the present invention with an exemplary rain cover installed thereon;

FIG. 29 is an isometric view of the other exemplary junction box according to the present invention;

FIG. 30 is an exploded view of the other exemplary junction box according to the present invention;

FIG. 31 is a top plan view of the other exemplary junction box according to the present invention;

FIG. 32 is a side view of the other exemplary junction box according to the present invention;

FIG. 33 is a back view of the other exemplary junction box according to the present invention;

FIG. 34 is an isometric view of the other exemplary junction box according to the present invention;

FIG. 35 is a side view of the other exemplary junction box according to the present invention with the exemplary rain cover installed thereon;

FIG. 36 is cross-sectional view of the exemplary junction box according to the present invention taken along line 36-36 in FIG. 28;

FIG. 37 is an exploded view demonstrating installation of the other exemplary junction box according to the present invention;

FIG. 38 is an isometric view of an exemplary installation the other exemplary junction box according to the present invention;

FIG. 39 is an isometric view of an exemplary installation the other exemplary junction box according to the present invention;

FIG. 40 is a side view of an exemplary installation the other exemplary junction box according to the present invention;

FIGS. 41-45 are top plan views of exemplary housing covers and units that may be used in connection with the other exemplary junction box according to the present invention;

FIG. 46 is an isometric view of the other exemplary junction box according to the present invention with an exemplary alternative housing cover installed thereon;

FIG. 47 is a top plan view of the other exemplary junction box according to the present invention with the exemplary alternative housing cover installed thereon;

FIG. 48 is a side view of the other exemplary junction box according to the present invention with the exemplary alternative housing cover installed thereon;

FIG. 49 is a side view of an exemplary installation of the other exemplary junction box according to the present invention with the exemplary alternative housing cover installed thereon;

FIG. 50 is a top plan view of the other exemplary junction box according to the present invention with exemplary wired connections made therein;

FIG. 51 is a top plan view of an exemplary mounting post that may be used in connection with the various exemplary junction boxes according to the present invention;

FIG. 52 is an isometric view of the exemplary mounting post from FIG. 51;

FIG. 53 is a front view of the exemplary mounting post from FIG. 51;

FIG. 54 is a side view of the exemplary mounting post from FIG. 51;

FIG. 56 is a bottom isometric view of the exemplary mounting post from FIG. 51;

FIG. 57 is a top plan view of an exemplary wire connecting post that may be used in connection with the various exemplary junction boxes according to the present invention;

FIG. 58 is a bottom isometric view of the exemplary wire connecting post from FIG. 57;

FIG. 59 is an isometric view of the exemplary wire connecting post from FIG. 57;

FIG. 60 is a side view of the exemplary wire connecting post from FIG. 57;

FIG. 61 is an isometric view of an exemplary configuration for the other exemplary junction box according to the present invention;

FIG. 62 is a top plan view of an exemplary divider plate that may be used in connection with the various exemplary junction boxes according to the present invention;

FIG. 63 is an isometric view of the exemplary divider plate from FIG. 62;

FIG. 64 is a front view of the exemplary divider plate from FIG. 62;

FIG. 65 is a side view of the exemplary divider plate from FIG. 62;

FIG. 66 is an isometric view of an exemplary configuration for the other exemplary junction box according to the present invention;

FIG. 67 is a top plan view of an exemplary configuration for the other exemplary junction box according to the present invention;

FIG. 68 is a top plan view of an exemplary grounding plate that may be used in connection with the various exemplary junction boxes according to the present invention;

FIG. 69 is a front view of the exemplary grounding plate from FIG. 68;

FIG. 70 is an isometric view of the exemplary grounding plate from FIG. 68;

FIG. 71 is a front view of another exemplary grounding plate that may be used in connection with the various exemplary junction boxes according to the present invention;

FIG. 72 is an isometric view of the exemplary grounding plate from FIG. 71;

FIG. 73 is an isometric view of the other exemplary junction box according to the present invention with a sconce cover installed thereon;

FIG. 74 is an exploded view of an exemplary sconce mounting plate installation on the other exemplary junction box according to the present invention;

FIG. 75 is an isometric view of the exemplary sconce mounting plate installation on the other exemplary junction box according to the present invention;

FIG. 76 is a cross-sectional view taken along line 76-76 in FIG. 75; and

FIG. 77 is a front view of the exemplary sconce mounting plate installation on the other exemplary junction box according to the present invention.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

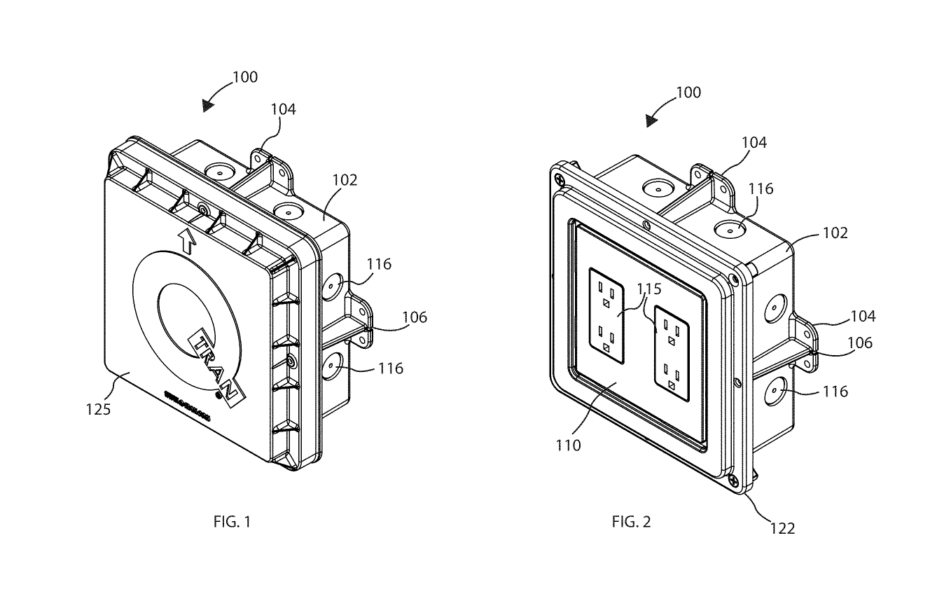

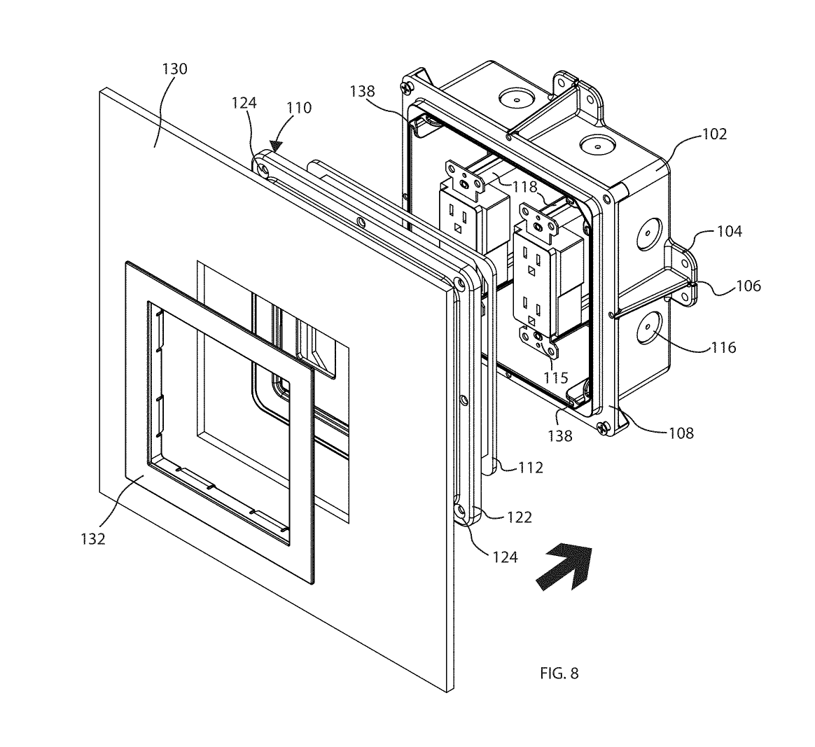

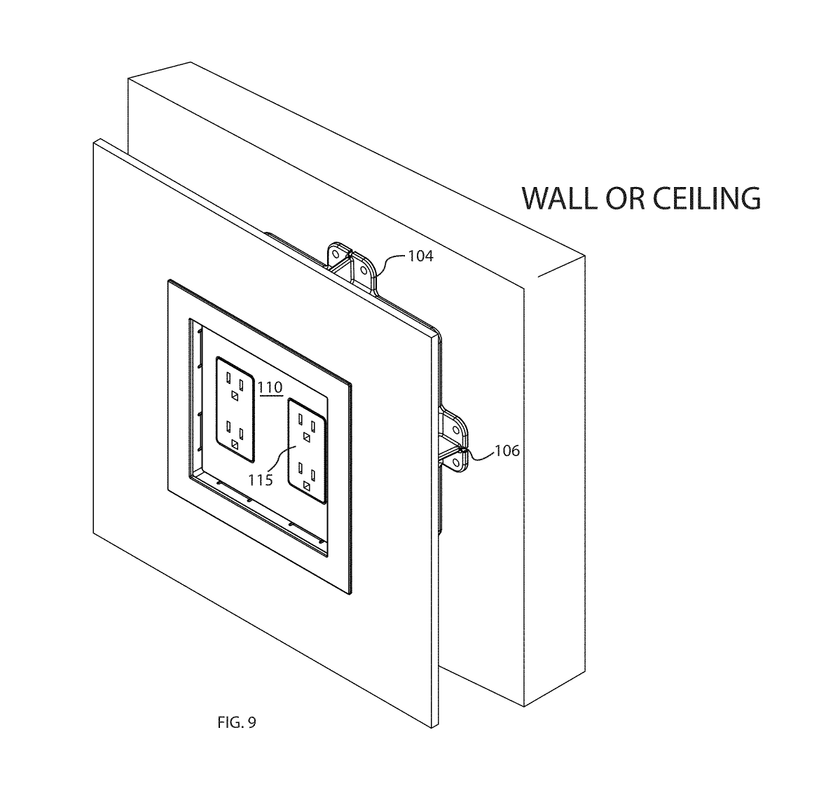

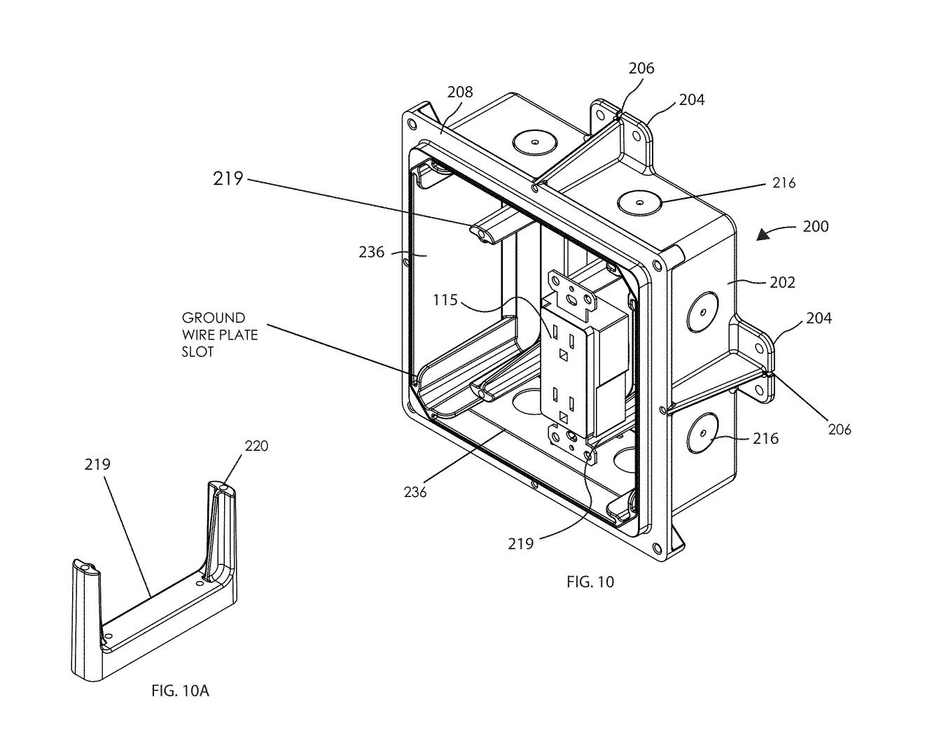

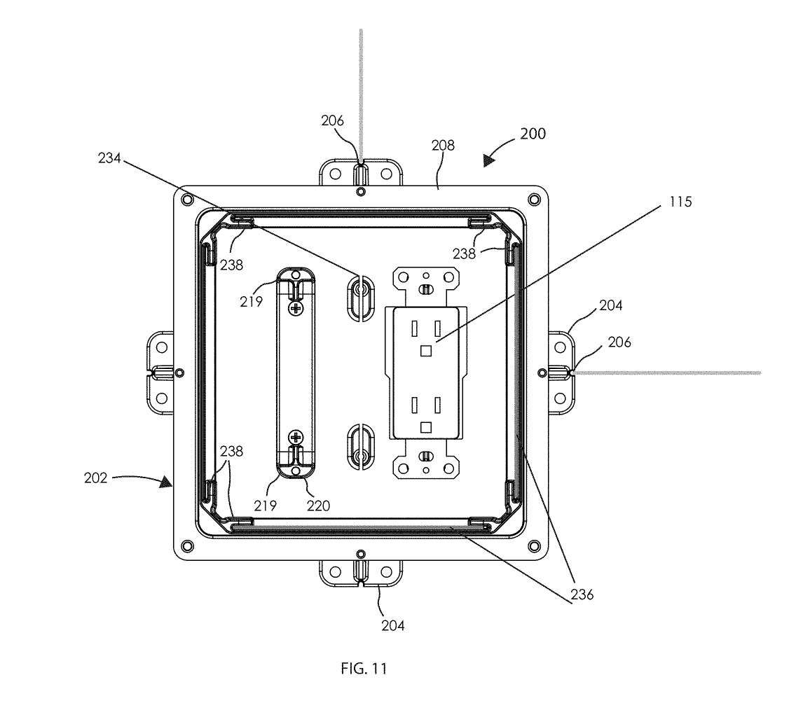

Referring now to FIGS. 1-3 and 8, therein illustrated is an exemplary embodiment of a junction box, generally indicated by reference numeral 100, according to the present invention. The junction box 100 includes a housing 102 that defines an interior region of the junction box 100. The housing 102 includes one or more mounting tabs 104 that are positioned on the housing 102 in order to allow the junction box 100 to be installed on a surface, such as a wall or ceiling surface as shown for example in FIG. 9. Referring again to FIGS. 1-3 and 8, the one or more mounting tabs 104 may each include an alignment notch 106 that are configured to facilitate installation of the junction box 100, by for example aligning the alignment notches 106 with pre-marked lines (see FIG. 11) on the wall surface. The housing 102 of the junction box 100 may also include a peripheral flange 108 extending at least partially around the perimeter of the housing 102. The peripheral flange 108 is configured to allow removable attachment of a housing cover 110 to the housing 102. In order to provide a watertight and/or rain-tight seal between the housing cover 110 and the housing 102, a sealing gasket 112 may be installed between the housing cover 110 and the housing 102. The housing cover 110 may be installed on the housing 102 through the use of one or more fasteners, such as screws, bolts or pins. The housing cover 110 may be configured to include one or more openings 114 to allow units 115, such as switches, electrical or data receptacles (e.g. FIGS. 14, 15 & 16), wall sconces (e.g. FIG. 18) to be installed in the housing 102 of the junction box 100 to protrude to the exterior of the junction box 100. Alternatively, the housing cover 110 may not include any openings 114, such as shown in FIG. 17 for example, to allow installation of power supplies, transformers and the like in the junction box 100.

Referring again to FIGS. 1-3 and 8, the housing 102 of the junction box 100 may also include one or more knock-outs 116 positioned in one or more wall, whether side, front and/or back/rear, of the housing 102 to act as entry ports for cables, such as electrical or data, to the interior region of the junction box 100. Preferably, the knock-outs 116 are dimensioned to receive standard electrical and/or data connectors, and are dimensioned according to the type of electrical and/or data conductors that are to be received by the junction box 100. Also preferably, the knock-outs 116 may be rain-tight when still integral with the housing 102 so that the rain-tight integrity of the junction box 100 may not be compromised unless the knock-out 116 is actually removed from the housing 102. After removal of the knock-out 116 the rain-tight integrity of the junction box 100 may be restored through the use of appropriate rain-tight electrical connectors (not shown). The housing 102 may also include one or more device mounting posts 118 that are configured to allow attachment of one or more units 115, such as switches and electrical or data receptacles. The device mounting posts 118 may be formed integrally with the housing 102, or attached to the housing so that the device mounting posts 118 are removable, as shown for example in FIGS. 10, 10A and 11 discussed further below with another exemplary embodiment of the junction box. It is understood that the device mounting posts 118 may be removable in order to accommodate a variety of electric devices in the junction box 100, such as, but not limited to, transformers. The device mounting posts 118 have ports 120 to receive and retain fasteners, such as screws and the like, that may be used to secure one or more units 115 to the device mounting posts 118.

Continuing to refer to FIGS. 1-3 and 8, the housing cover 110 may also include a perimeter flange 122 that may include one or more openings 124 through which fasteners may be used to removably secure the housing cover 110 to the housing 102. The openings 124 may also be used to removably secure a removable cover 125 to the housing cover 110. The removable cover 125 may be reusable or disposable. A gasket 126 may be placed between the housing cover 110 and the removable cover 125 in order to provide a rain-tight seal between the housing cover 110 and the removable cover 125. In this manner, the junction box 100 may be made rain-tight even after the units 115 have been installed in the junction box 100. This provides for physical protection from damage and prevents intrusion of dust, dirt, debris and/or water, and thereby obviates the need to otherwise protect the junction boxes 100 during shipment, construction and after installation in a structure, but before the structure has been sufficiently finished so as to be able to exclude the elements. The removable cover 125 allows for the junction box 100 to be physically protected from damage and intrusion of particles from the original manufacturing location to transport to a further manufacturing location, such as a location that would integrate the junction box 100 into a pre-fabricated wall structure, and during transport to and installation in the building structure prior to the building structure being sufficiently finished so as to exclude the elements.

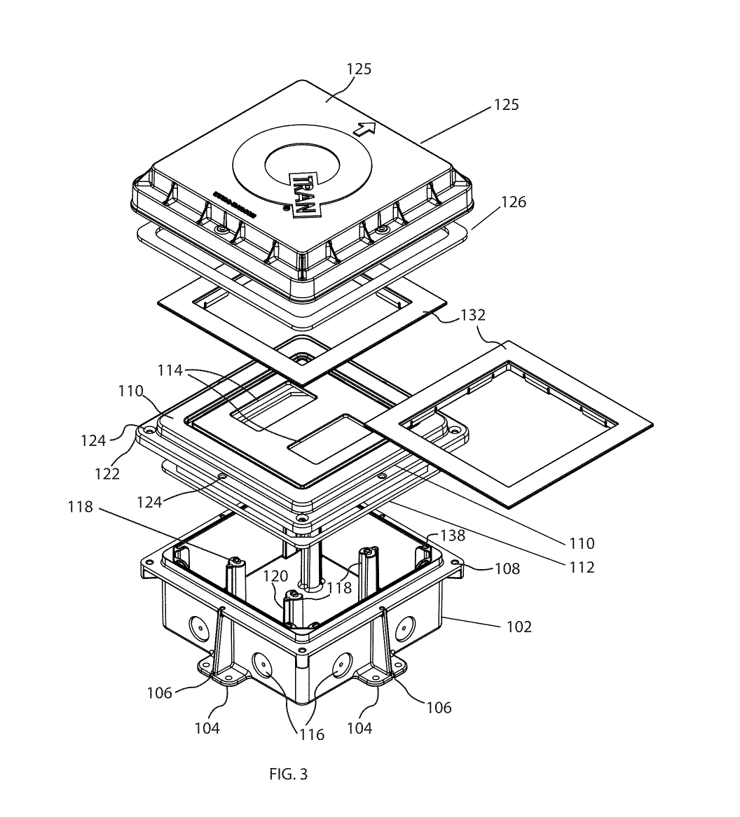

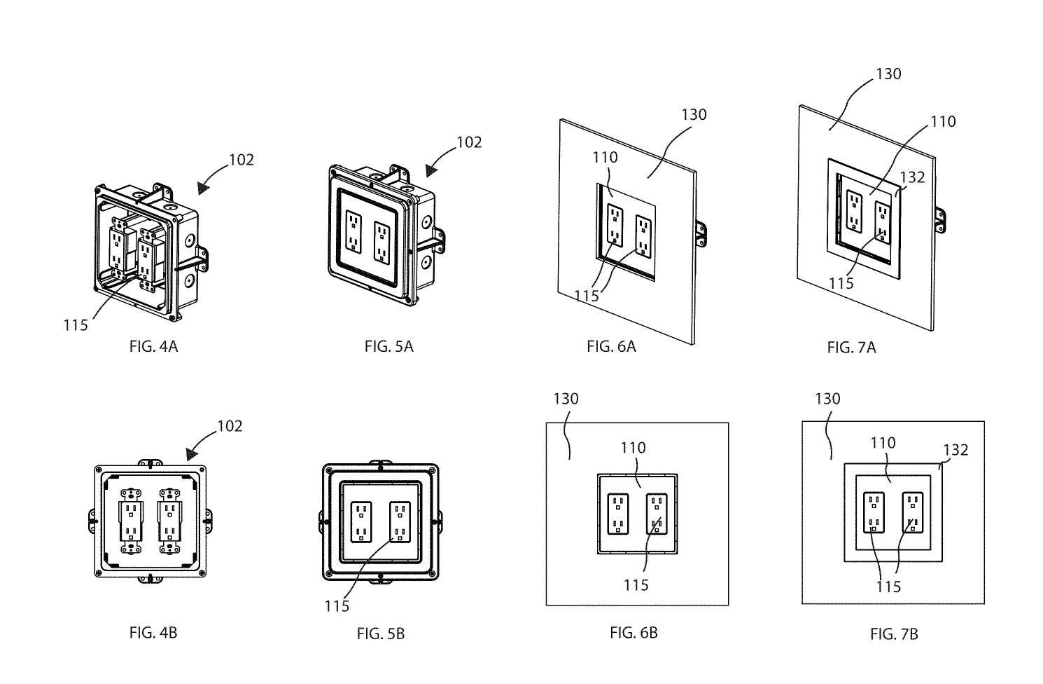

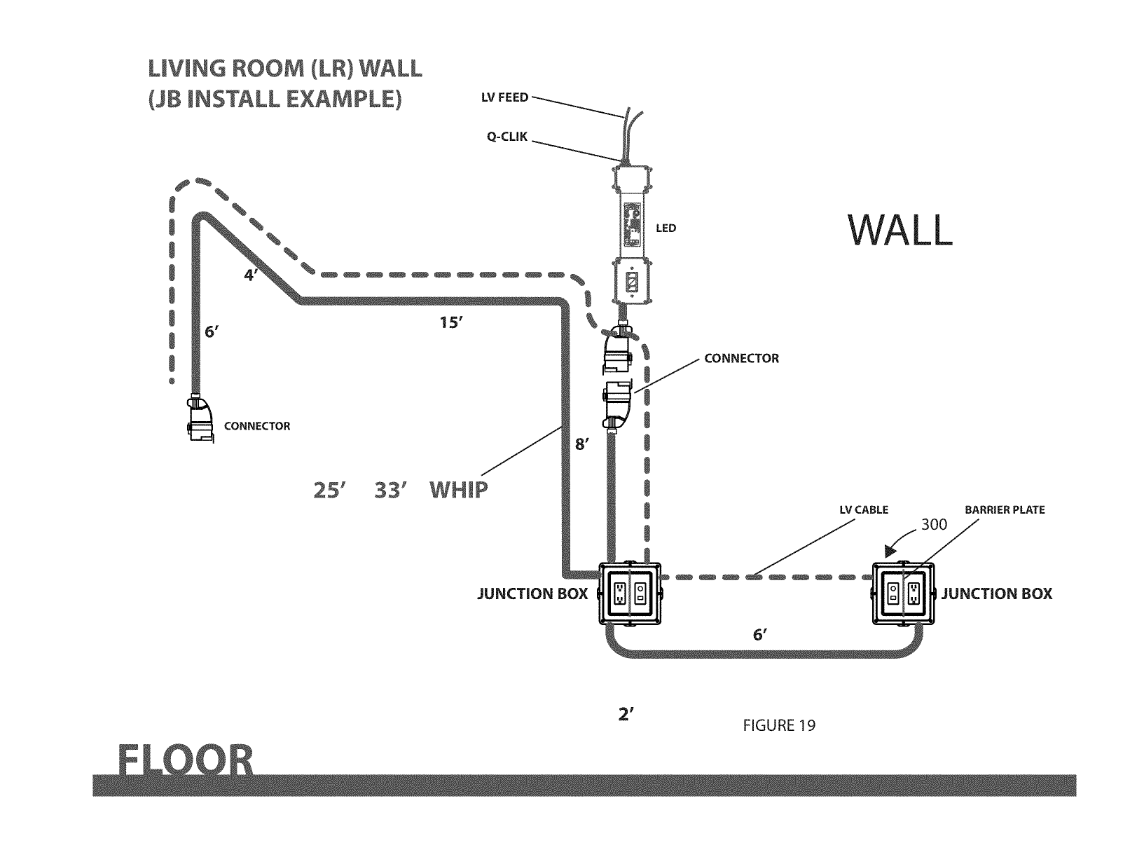

Referring now to FIGS. 3, 6A, 6B, 7A, 7B, 8-9 and 19, the installation of the junction box 100 will be discussed. The junction box 100 may be mounted on the surface through the use of the one or more mounting tabs 104. Once installed, or even prior to installation, the units 115 are attached to the mounting posts 118, and the housing cover 110 may then be installed, with the gasket 112 fixed between the housing cover 110 and the housing 102. Electrical wires, cables and/or conduit may be connected to the junction box 100, as shown in FIG. 19 for example, by removing one or more of the knock-outs 116 and coupling the wires, cables and/or conduit to the junction box 100 by suitable connectors. In certain applications, a décor or aligning panel 130 may be placed around the junction box 100. It is understood that the décor panel 130 may comprise the entire wall or ceiling covering or cover substantial portions of the wall or ceiling. In order to provide a finished look for the installed junction box 100, a snap-in frame 132 may be installed on the junction box 100 and décor panel 130.

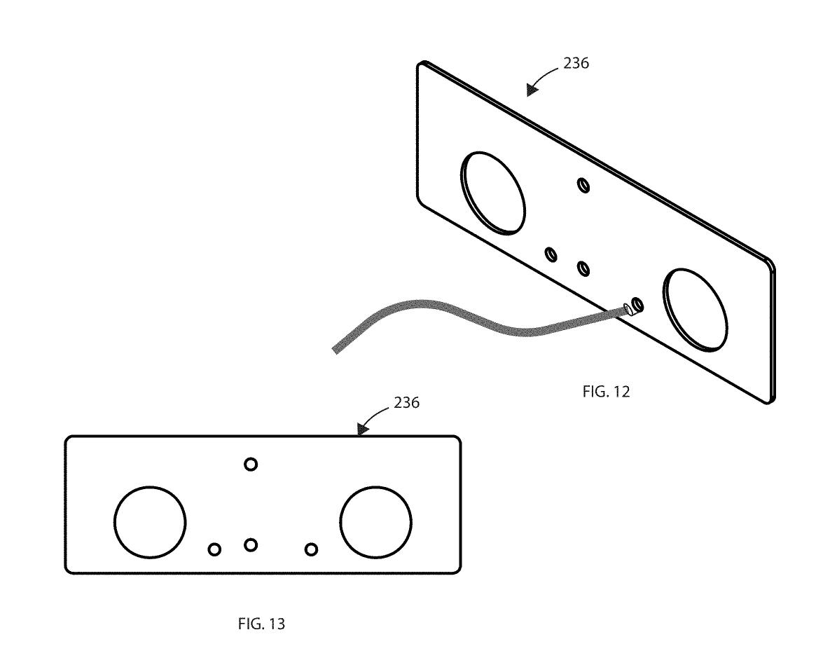

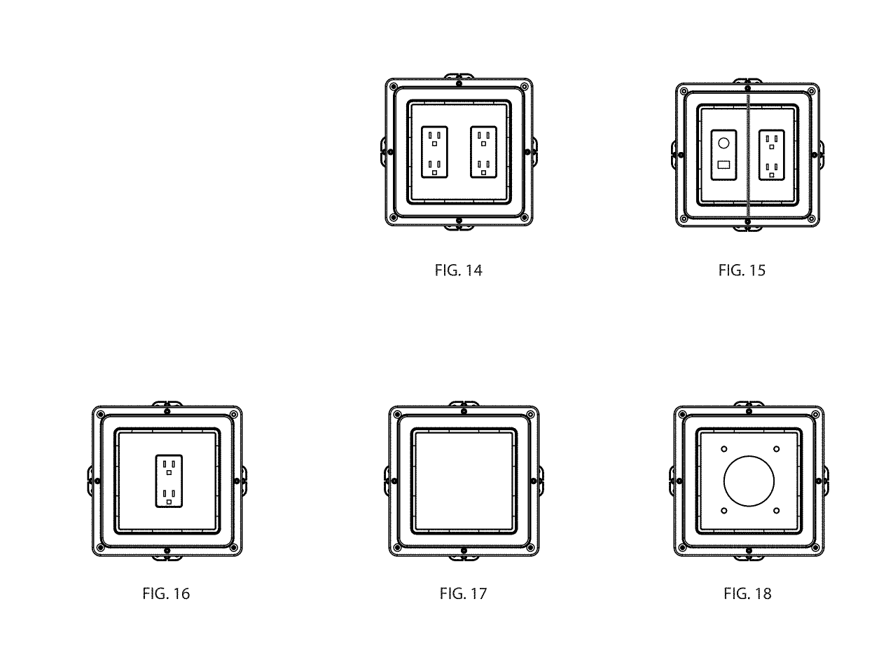

Referring now to FIGS. 10, 10A and 11-13, therein illustrated is another exemplary embodiment of a junction box, generally indicated by reference numeral 200, according to the present invention. The junction box 200 includes a housing 202 that defines an interior region of the junction box 200. The housing 202 includes one or more mounting tabs 204 that are positioned on the housing 202 in order to allow the junction box 200 to be installed on a surface, such as a wall or ceiling surface. The one or more mounting tabs 204 may each include an alignment notch 206 that are configured to facilitate installation of the junction box 200, by for example aligning the alignment notches 206 with pre-marked lines (see FIG. 11) on the wall surface. The housing 202 of the junction box 200 may also include a peripheral flange 208 extending at least partially around the perimeter of the housing 202. The peripheral flange 208 is configured to allow removable attachment of a housing cover (not shown) to the housing 202. The housing cover that may be used with the junction box 200 is the same or substantially the same as the housing cover 110 used with junction box 100 discussed above. The housing 202 of the junction box 200 may also include one or more knock-outs 216 positioned in one or more wall, whether side and/or back/rear, of the housing 202 to act as entry ports for cables, such as electrical or data, to the interior region of the junction box 200. Preferably, the knock-outs 216 are dimensioned to receive standard electrical and/or data connectors, and are dimensioned according to the type of electrical and/or data conductors that are to be received by the junction box 200. Also preferably, the knock-outs 216 may be rain-tight when still integral with the housing 202 so that the rain-tight integrity of the junction box 200 may not be compromised unless the knock-out 216 is actually removed from the housing 202. After removal of the knock-out 216 the rain-tight integrity of the junction box 200 may be restored through the use of appropriate rain-tight electrical connectors (not shown). The housing 102 may also include one or more device mounting posts 219 that are configured to allow attachment of one or more units 115, such as switches and electrical or data receptacles. The device mounting posts 219 may be removable. It is understood that the device mounting posts 219 may be removable in order to accommodate a variety of electric devices in the junction box 100, such as, but not limited to, transformers and/or power supplies. The device mounting posts 219 have ports 220 to receive and retain fasteners, such as screws and the like, that may be used to secure one or more units 115 to the device mounting posts 219.

Referring now to FIG. 11, the junction box 200 may also include a barrier plate slot 234 that is configured to receive a barrier plate (not shown) that can be used to divide the junction box 200 into separate portions. Such a barrier plate may be desirable in order to permit using the junction box for distinct types of electrical uses, such as low voltage data and regular power.

Referring now to FIGS. 10 and 11-13, the junction box 200 may also include a grounding plate 236 that may be installed one or more sides of the housing 202. The grounding plate 236 can be used to both reinforce the sides of the housing 202 when electrical connectors are installed on the junction box 200, and to electrically ground the units 115 to the metallic electrical cables and/or conduit (not shown) connected to the junction box 200 by electrically bonding the ground conductor to the grounding plate 236, which is thereby electrically bonded to the cables and/or conduit. The grounding plate 236 may be slid and retained in place on the housing 202 by one or more tabs 238 extending from the housing 202.

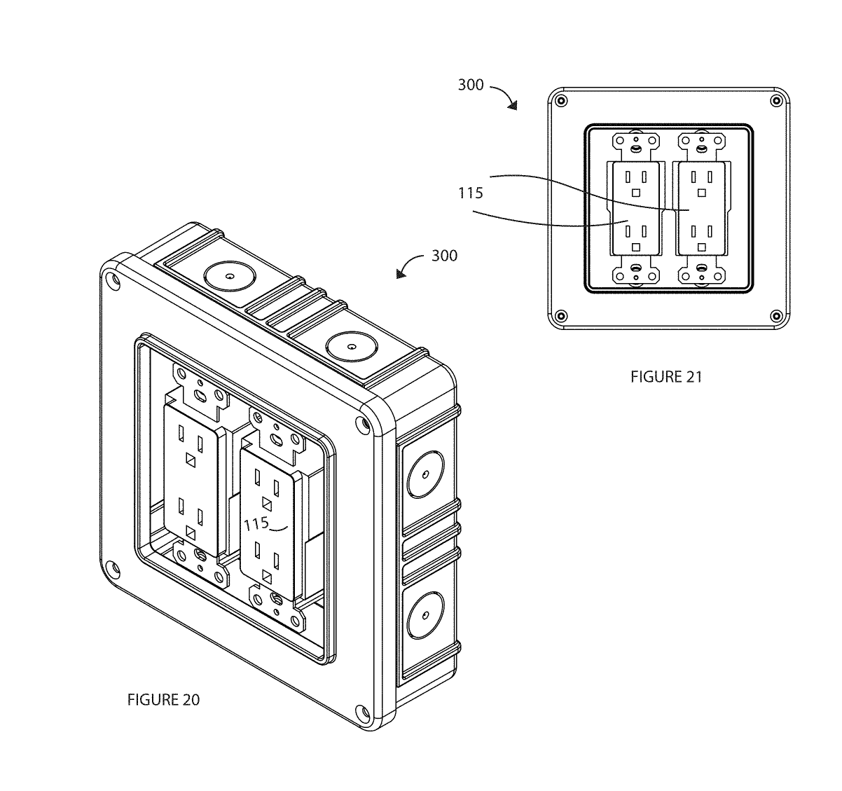

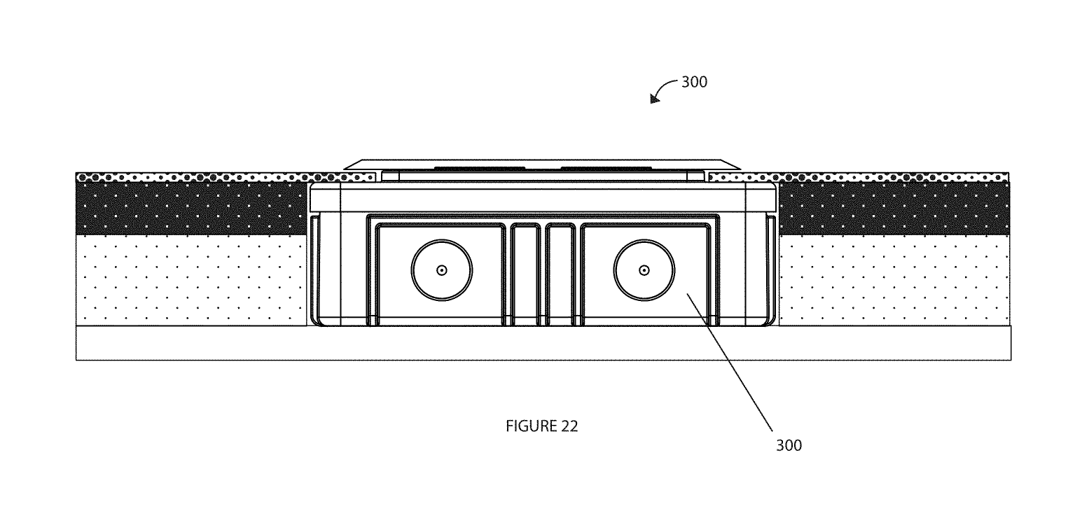

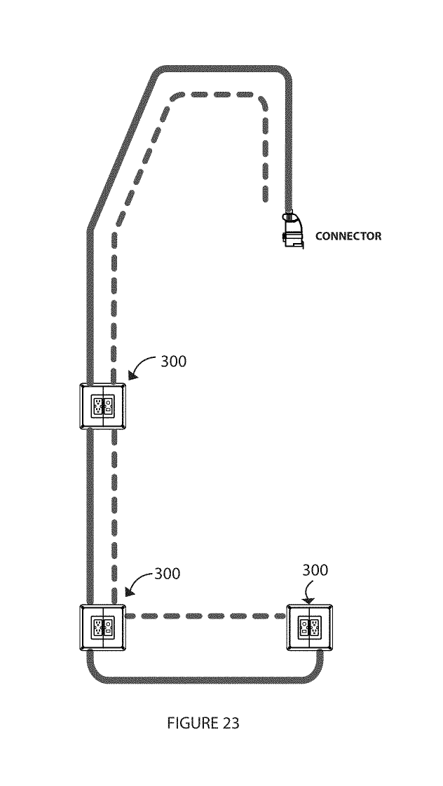

Referring now to FIGS. 20-22, therein illustrated is another exemplary embodiment of a junction box, generally indicated by reference numeral 300, according to the present invention. The junction box 300 is constructed and includes many of the same features as the junctions boxes 100 and 200 discussed above, and is suitable for use in a floor, as shown for example in FIG. 22. The junction box 300 may be connected to other junction boxes 300 through the use of suitable electrical wires, cables and/or conduits, as shown for example in FIG. 23.

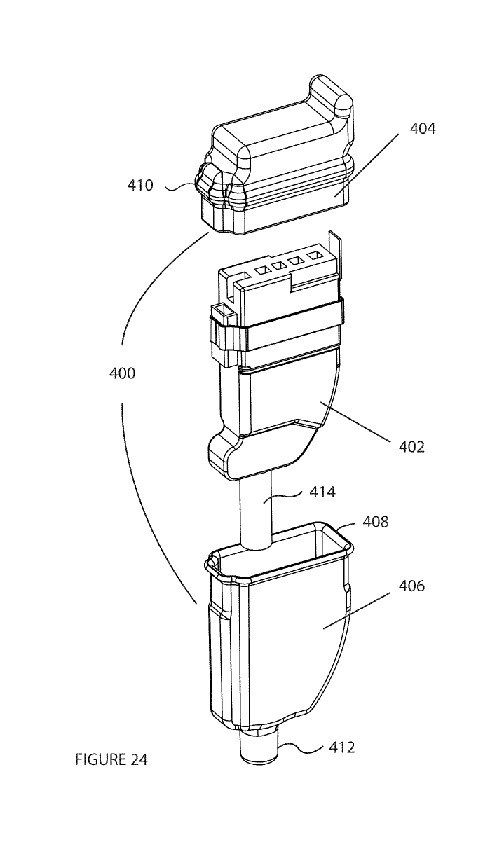

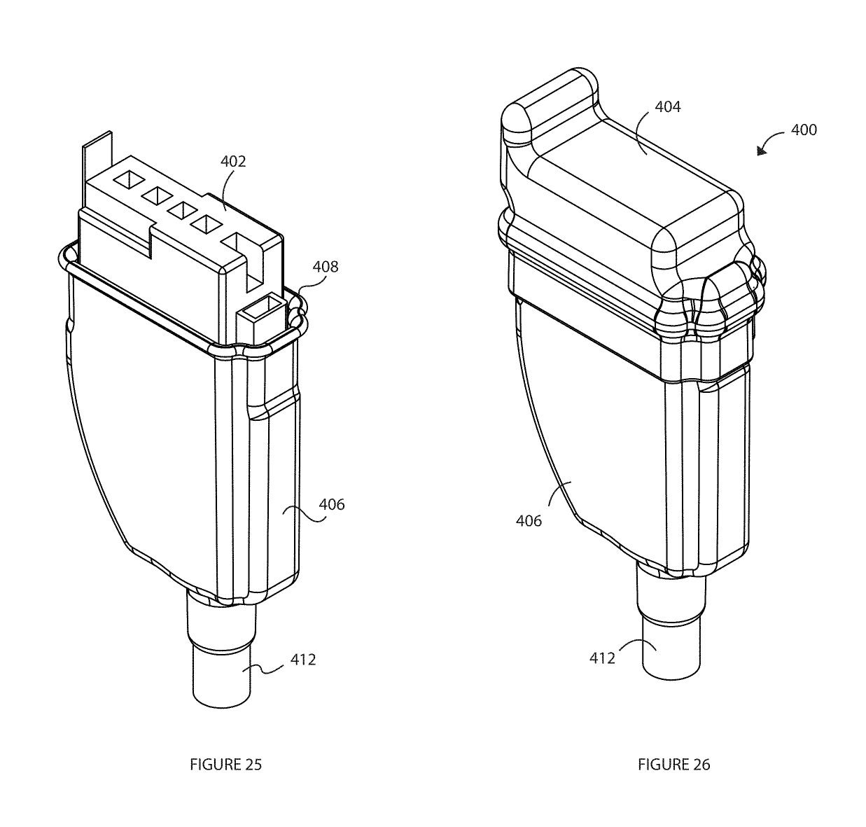

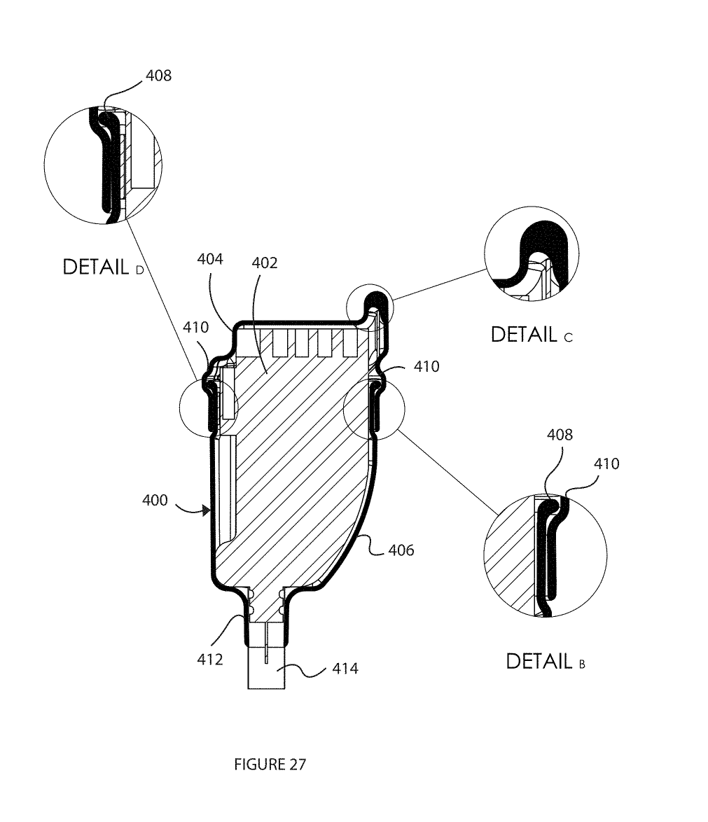

Referring now to FIGS. 24-27, therein illustrated is an exemplary water protection boot, generally indicated by reference numeral 400, for sealing water from an electrical connector 402. The water protection boot 400 includes a top boot portion 404 and a bottom boot portion 406. The bottom boot portion 406 includes a peripheral lip 408 that extends from the bottom boot portion 406 around the opening of the bottom boot portion 406. The top boot portion 404 includes an interior perimeter channel 410 that is dimensioned to receive the peripheral lip 408 when the top boot portion 404 is applied over the bottom boot portion 406. The interior perimeter channel 410 and the peripheral lip 408 act together to form a substantially water tight seal between the top boot portion 404 and the bottom boot portion 406. The seal between the top boot portion 404 and bottom boot portion 406 may be augmented by tape or other sealant (not shown). The bottom boot portion 406 may also further include a neck 412 that is adapted to securely seal any cables, wires and/or conduits 414 connected with the connector 402, and the seal between the neck 412 and the conduits 414 may be augmented by tape or other sealant (not shown).

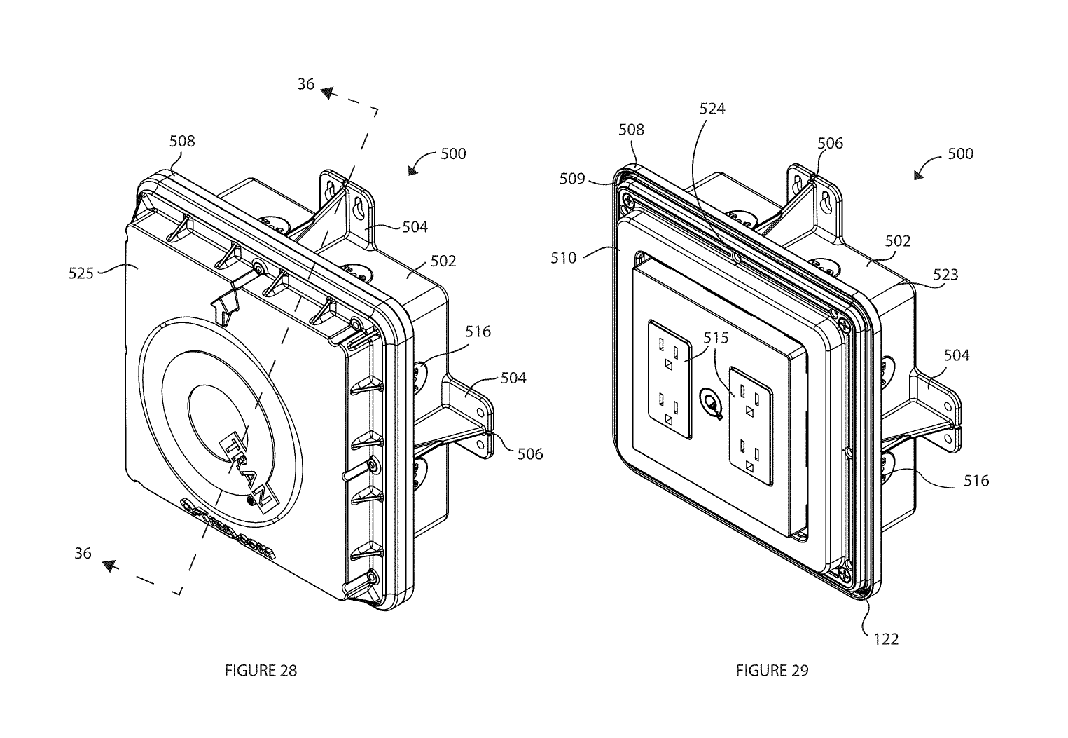

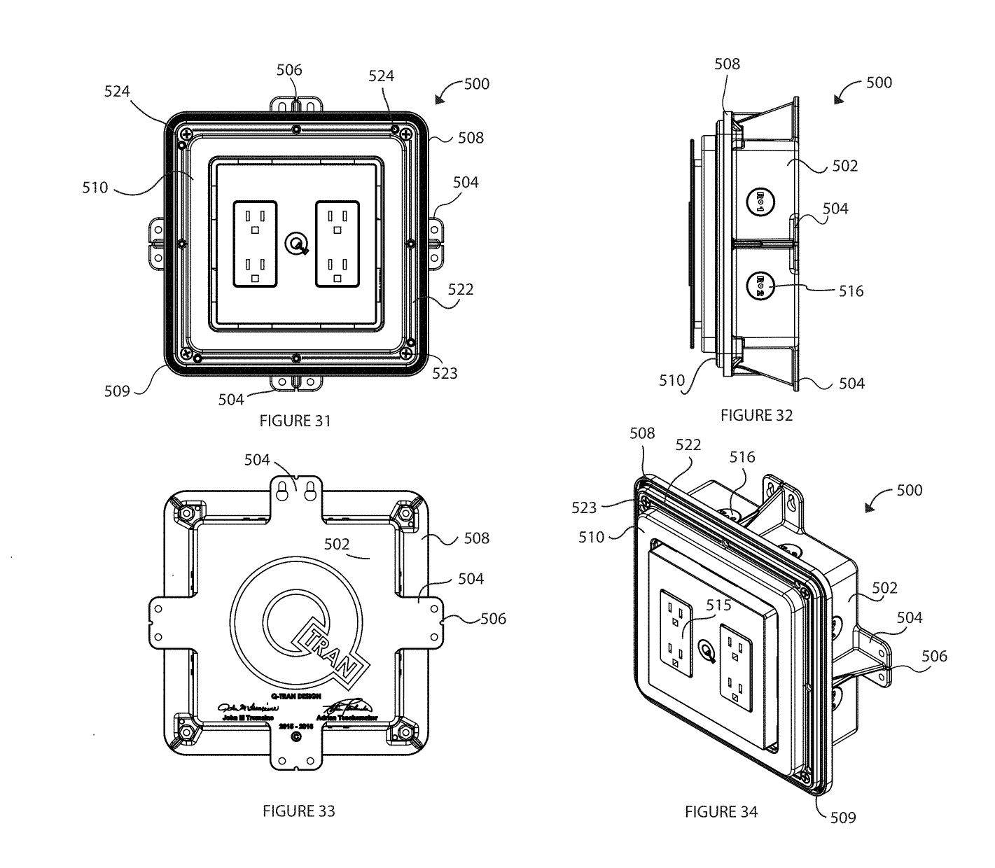

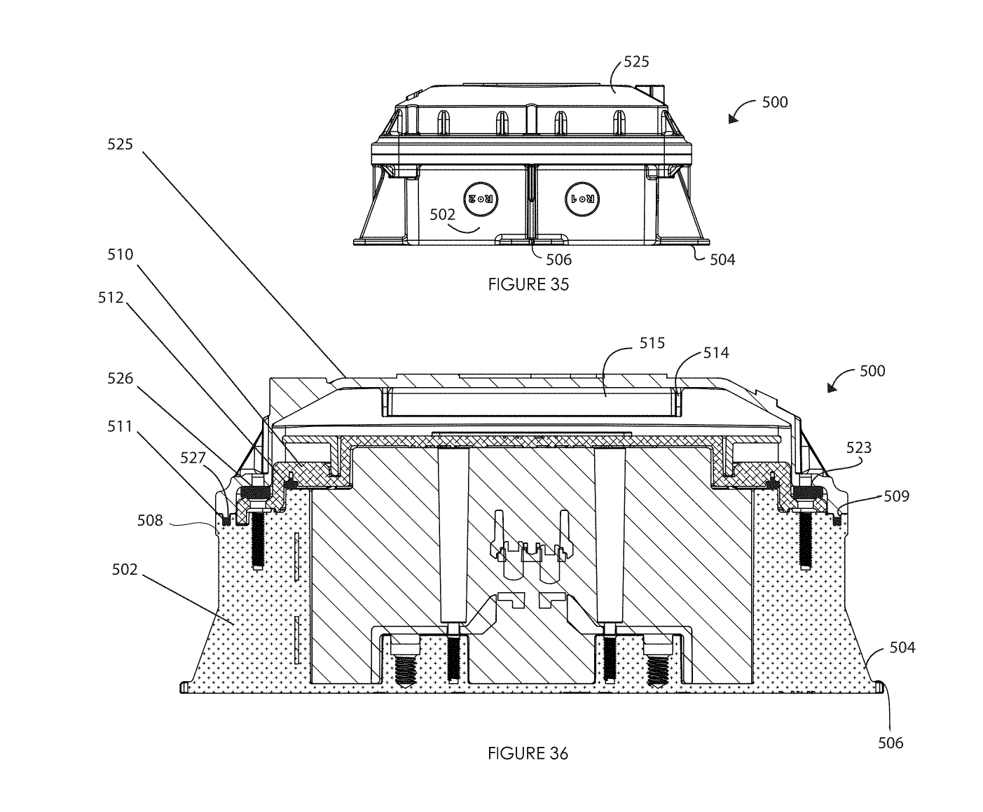

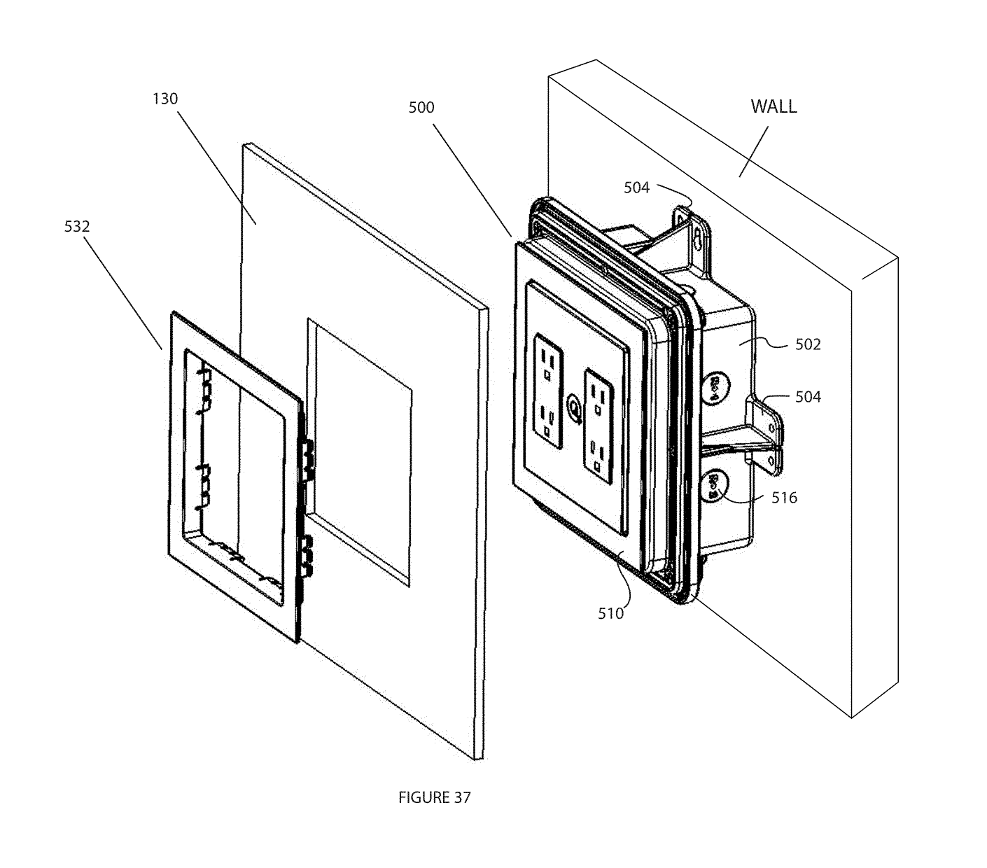

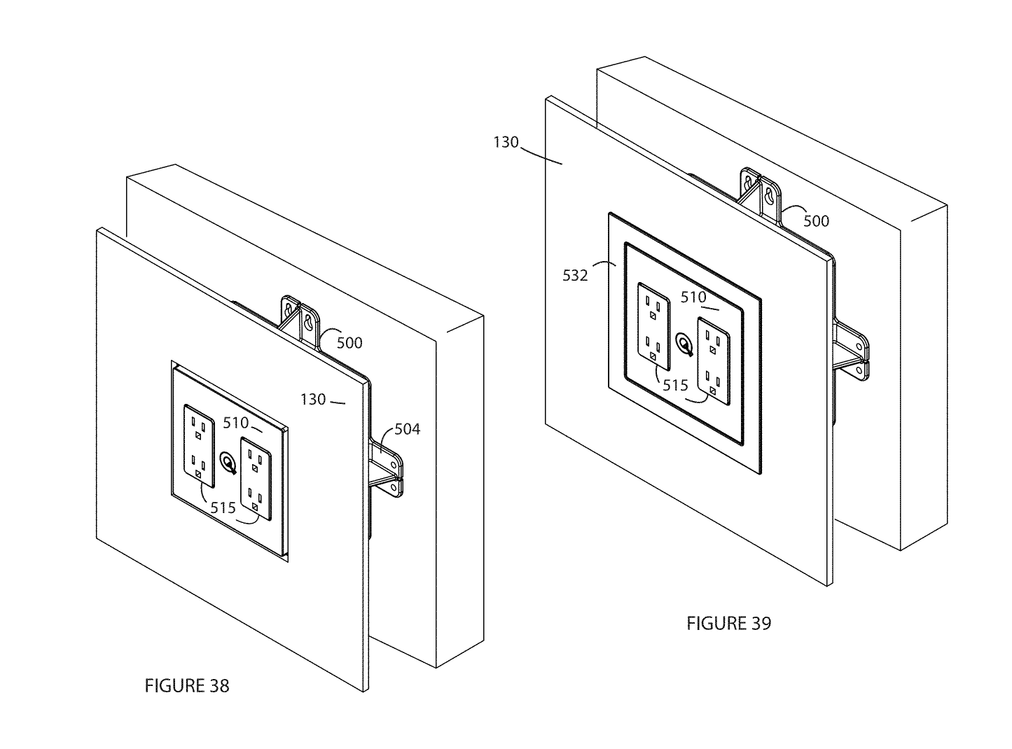

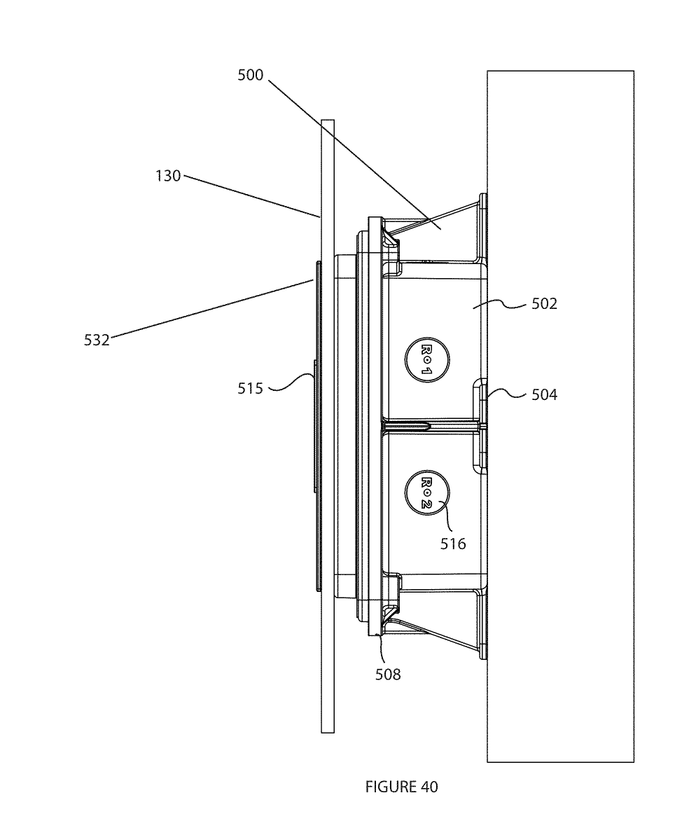

Referring now to FIGS. 28-36, therein illustrated is an exemplary embodiment of a junction box, generally indicated by reference numeral 500, according to the present invention. The junction box 500 includes a housing 502 that defines an interior region of the junction box 500. The housing 502 includes one or more mounting tabs 504 that are positioned on the housing 502 in order to allow the junction box 500 to be installed on a surface, such as a wall or ceiling surface as shown for example in FIGS. 37-40. Referring again to FIGS. 28-36, the one or more mounting tabs 504 may each include an alignment notch 506 that are configured to facilitate installation of the junction box 500, by for example aligning the alignment notches 506 with pre-marked lines (not shown) on the wall surface. The housing 502 of the junction box 500 may also include a peripheral flange 508 extending at least partially around the perimeter of the housing 502. The peripheral flange 508 is configured to allow removable attachment of a housing cover 510 to the housing 502. The peripheral flange 508 may include a perimeter channel 509 extending around at least a portion of the perimeter of the peripheral flange 508, and the perimeter channel 509 may be adapted to receive a gasket 511. The gasket 511 may be positioned within the perimeter channel 509, and is configured for compression between a removable cover 525 and the perimeter channel 509 of the peripheral flange 508. The removable cover 525 may be reusable or disposable. The removable cover 525 is configured for removable attachment to the housing 502, either directly or through interaction with the housing cover 510, as discussed further below. The removable cover 525 may include a circumferential lip 527 that is configured to disposition within the perimeter channel 509 of the peripheral flange 509, and may be further configured to interact with the gasket 511 in order to increase the seal that may be formed between the removable cover 525 and the housing 502. It is understood that the gasket 511 may optionally be disposed within the perimeter channel 509, but when provided the gasket 511 acts as a first sealing mechanism between the removable cover 525 and the housing 502.

Still referring to FIGS. 28-36, the housing cover 510 may also include a perimeter flange 522 that may include one or more openings 524 through which fasteners 523 may be used to removably secure the housing cover 510 to the housing 502. The housing cover 510 may be installed on the housing 502 through the use of one or more fasteners 523, such as screws, bolts or pins. The openings 524 may also be used to removably secure the removable cover 525 to the housing cover 510. A gasket 526 may be optionally be placed between the housing cover 510 and the removable cover 525 in order to provide a rain-tight seal between the housing cover 510 and the removable cover 525. In order to provide a watertight and/or rain-tight seal between the housing cover 510 and the housing 502, a sealing gasket 512 may be installed between the housing cover 510 and the housing 502. The gasket 512 may also be disposed between the housing cover 510 and the housing 502 in order to provide at least a substantially water-tight seal between the housing cover 510 and the housing 502. It is understood that any combination of gaskets 511, 512, 526 may be provided with the junction box 500 depending upon the desired level of water resistance and/or tightness required. For example, since the removable cover 525 may be of a unitary construction it is understood that the gasket 511 may be sufficient to seal the junction box 500 when the removable cover 525 is installed on the housing 502. It is further understood that the gasket 526 provides a seal and/or a further seal against water intrusion between the removable cover 525 and the housing cover 510, while the gasket 512 provides a seal and/or a further seal against water intrusion between the housing cover 510 and the housing 502. The removable cover 525 in combination with one or more of the gaskets 511, 512, 526 is configured to provide for physical protection from damage and prevents intrusion of dust, dirt, debris and/or water, and thereby obviates the need to otherwise protect the junction boxes 500 after installation in a structure, but before the structure has been sufficiently finished so as to be able to exclude the elements. The removable cover 525 allows for the junction box 100 to be physically protected from damage and intrusion of particles from the original manufacturing location to transport to a further manufacturing location, such as a location that would integrate the junction box 500 in order a pre-fabricated wall structure, and during transport to and installation in the building structure prior to the building structure being sufficiently finished so as to exclude the elements.

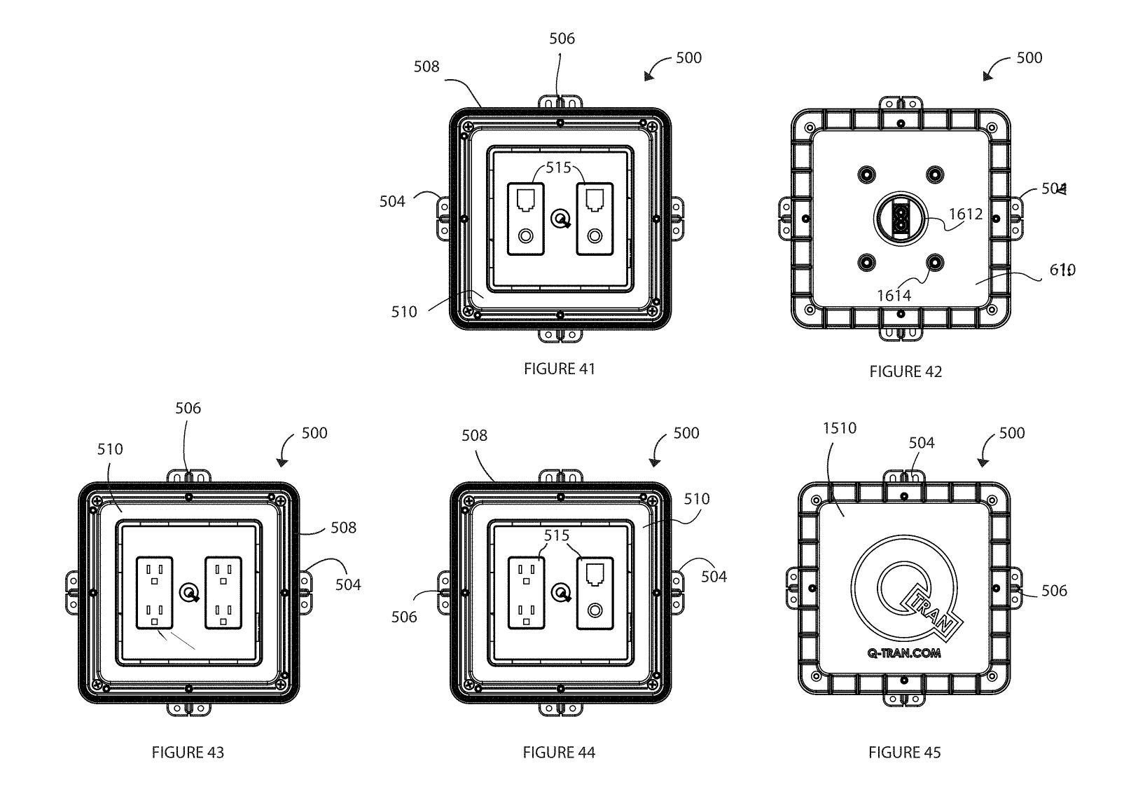

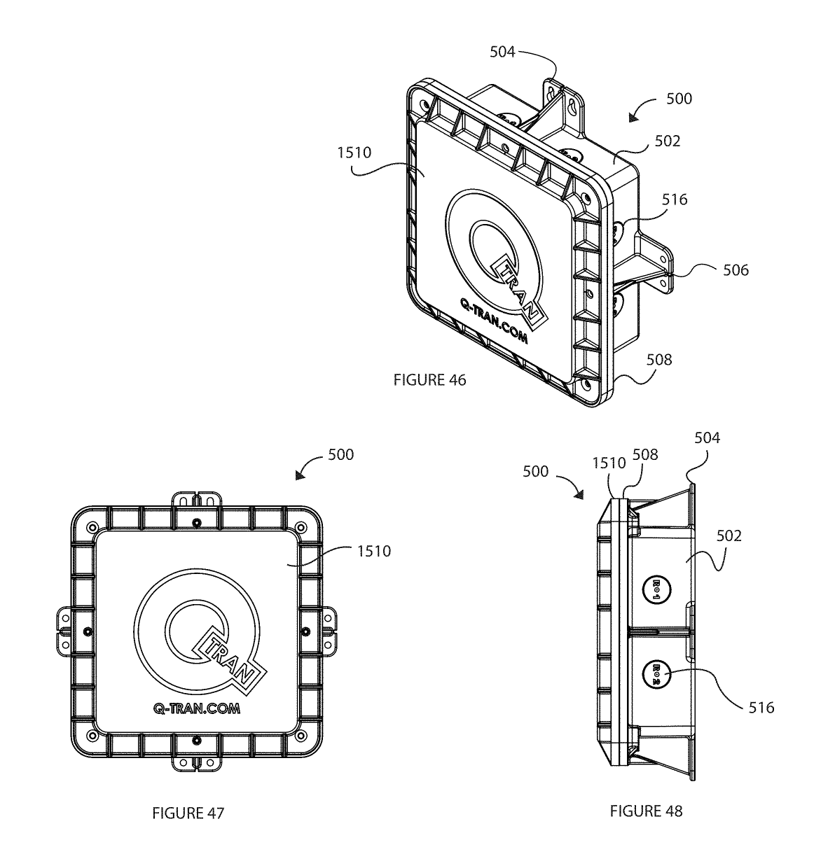

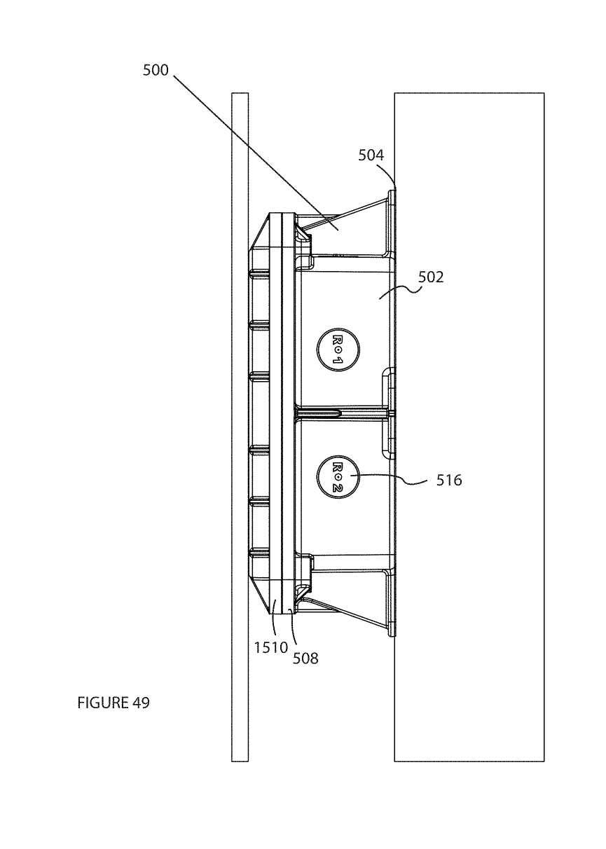

Continuing to refer to FIGS. 28-36, the housing cover 510 may be configured to include one or more openings 514 to allow units 515, such as switches, electrical, data receptacles (e.g. FIGS. 41 & 43-44) or wall sconces (e.g. FIG. 42), which are installed in the housing 502 of the junction box 500 to be exposed to the exterior of the junction box 500. Alternatively, the housing cover 510 may not include any openings 514, such as shown in FIGS. 45-49 for example, to allow installation of power supplies, transformers and the like in the junction box 500. The exemplary embodiment of the junction box 500 shown in FIGS. 45-49 includes the same components as the junction box 500 discussed above, with the exception that the housing cover 1510 is devoid of any openings. This permits the junction box 500 with the housing cover 1510 installed thereon to be positioned between a wall or ceiling surface and a décor panel, as shown for example in FIG. 49. It is understood that the housing cover 1510 may be used in connection with the housing 502 of the junction box 500 whenever it may not be needed to include units 515 or covering of the internal components of the junction box 500 is desired and/or required.

Referring again to FIGS. 28-36, the housing 502 of the junction box 500 may also include one or more knock-outs 516 positioned in one or more wall, whether side, front and/or back/rear, of the housing 502 to act as entry ports for cables, such as electrical or data, to the interior region of the junction box 500. Preferably, the knock-outs 516 are dimensioned to receive standard electrical and/or data connectors, and are dimensioned according to the type of electrical and/or data conductors that are to be received by the junction box 500. Also preferably, the knock-outs 516 may be rain-tight when still integral with the housing 502 so that the rain-tight integrity of the junction box 500 may not be compromised unless the knock-out 516 is actually removed from the housing 502. After removal of the knock-out 516 the rain-tight integrity of the junction box 500 may be restored through the use of appropriate rain-tight electrical connectors (not shown). One or more of the knock-outs 516 may include indicia thereon providing an indication of the relative location of the respective knock-out 516 on the junction box 500. For example, a particular knock-out 516 may include an indication in the form of an imprinted, engraved, embossed, recessed and/or painted indicia that identifies the knock-out 516 as a right-positioned knock-out 516 relative to the junction box 500. The indicia can be used during installation of the junction box 500 in order to provide specific installation instructions as to which knock-outs 516 should be removed, and which connections should be made with respect to which knock-outs 516.

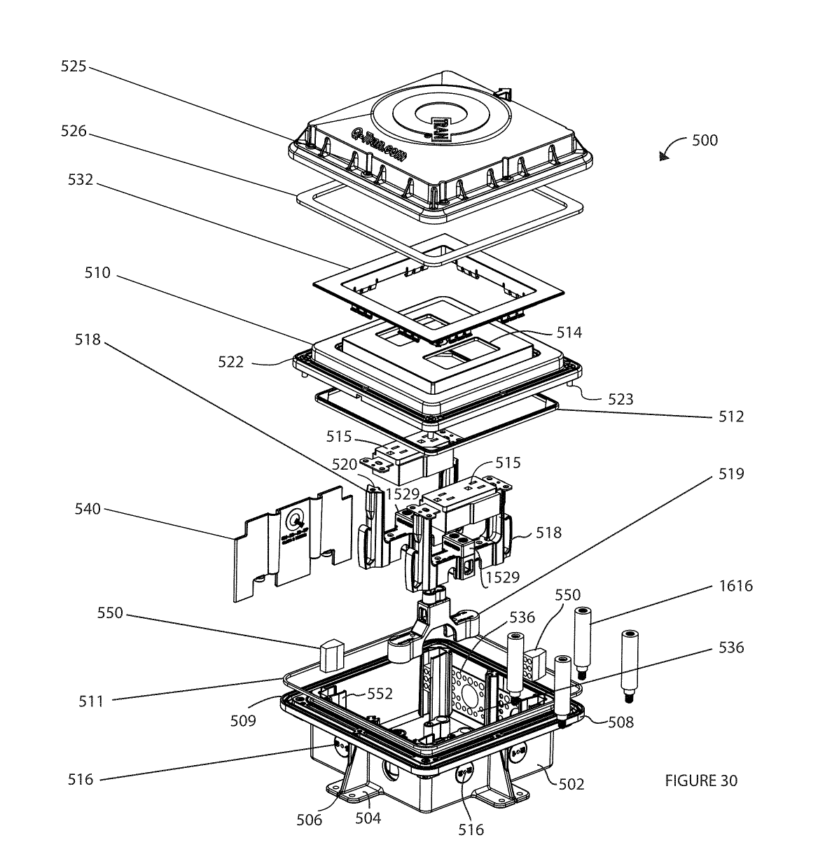

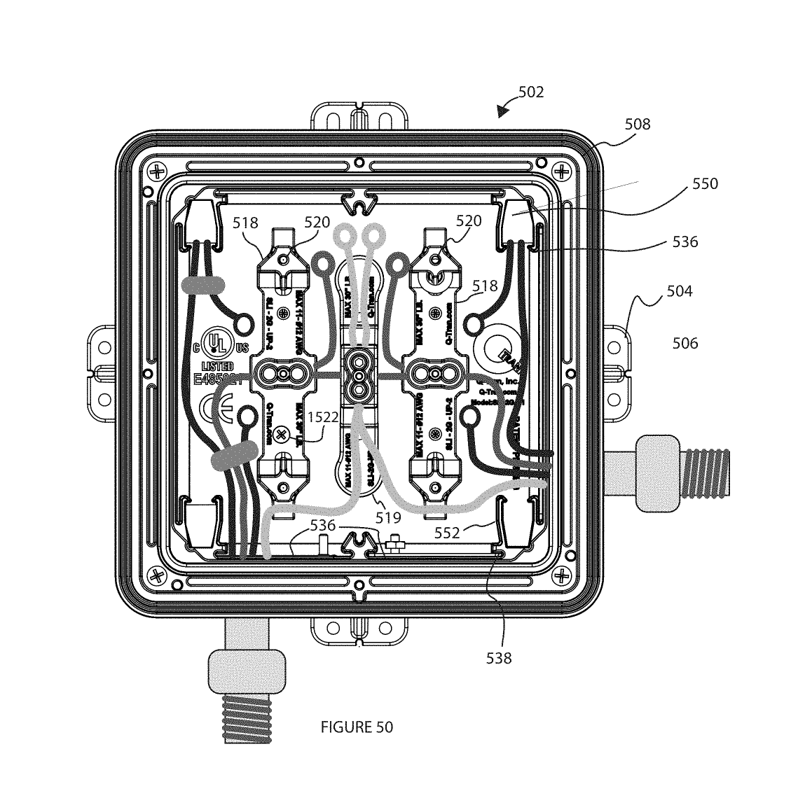

Referring now specifically to FIGS. 30 and 50, the junction box 500 may also include one or more device mounting posts 518 that are configured to allow attachment of one or more units 515, such as switches and electrical or data receptacles. The device mounting posts 518 may be formed integrally with the housing 502, or attached to the housing so that the device mounting posts 518 are removable, as shown for example in FIG. 30. It is understood that the device mounting posts 518 may be removable in order to accommodate a variety of electric devices in the junction box 500, such as, but not limited to, transformers. The device mounting posts 518 may include ports 520 to receive and retain fasteners, such as screws and the like, that may be used to secure one or more units 515 to the device mounting posts 518. The device mounting post 518 may be positioned in any one of three locations within the housing 502, depending upon the types and/or sizes of units 515 installed therein. For example, while a left and a right position of the device mounting post 518 is shown, the device mounting post 518 may also be positioned substantially at the center of the housing 502.

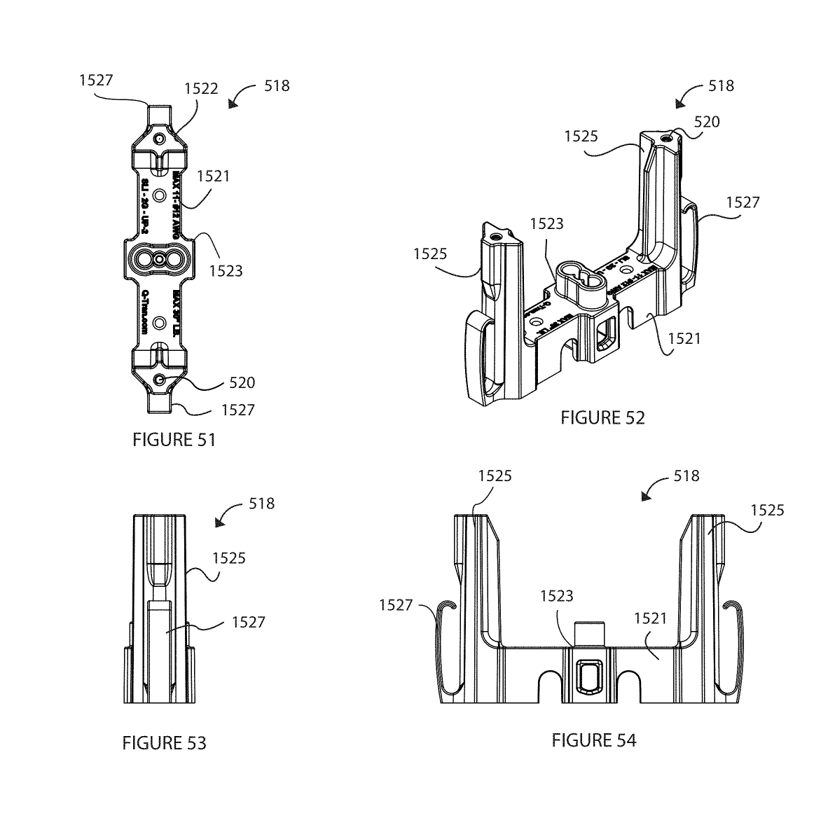

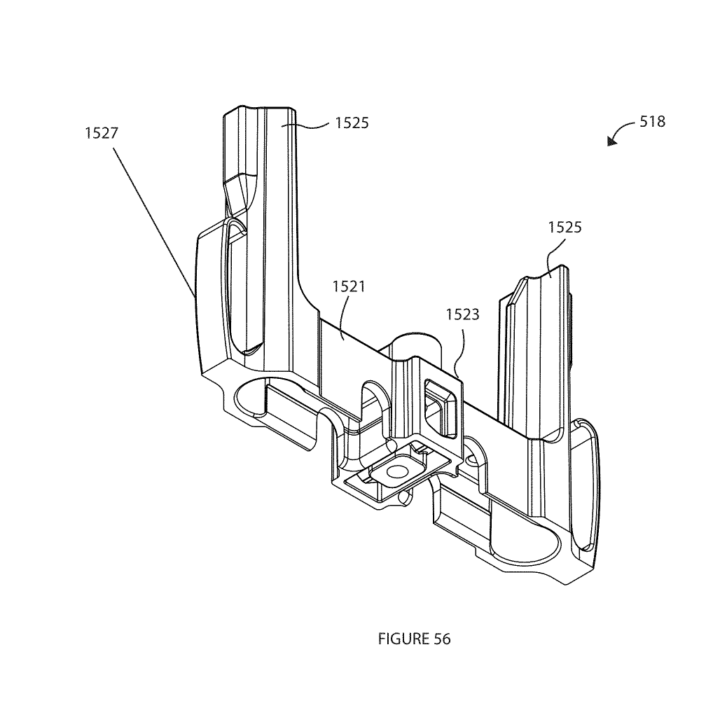

Referring now to FIGS. 51-56, therein illustrated is the device mounting post 518. The device mounting post 518 may include a base portion 1521 that is configured to engage with the housing 502 of the junction box 500. The base portion 1521 may be configured to be press-fit into the housing 502 of the junction box 500, and/or the base portion 1521 may be secured to the housing 502 by one or more fasteners 1522 (see FIG. 50). The base portion 1521 may include a terminal block receptacle 1523 that is dimensioned and configured to receive a suitable terminal block (see FIG. 56) that can be utilized to facilitate the connections made within the junction box 500. For example, FIG. 50 demonstrates the possible electrical connections that may be pre-wired in the junction box 500 using the mounting posts 518 and terminal blocks (not shown) installed therein. Referring again to FIGS. 51-56, the mounting post 518 may include a pair of stanchions 1525 that can be used to support and position the units 515 installed on the mounting post 518. The mounting post 518 may also include one or more wire management clips 1527 that can be used to retain wires positioned within the junction box 500. As shown for example in FIG. 30, the mounting post 518 may further include a finish cap 1529 that may be installed over the terminal block receptacle 1523 to provide an indication that the appropriate connections have been made with the terminal block (not shown) positioned within the mounting post 518.

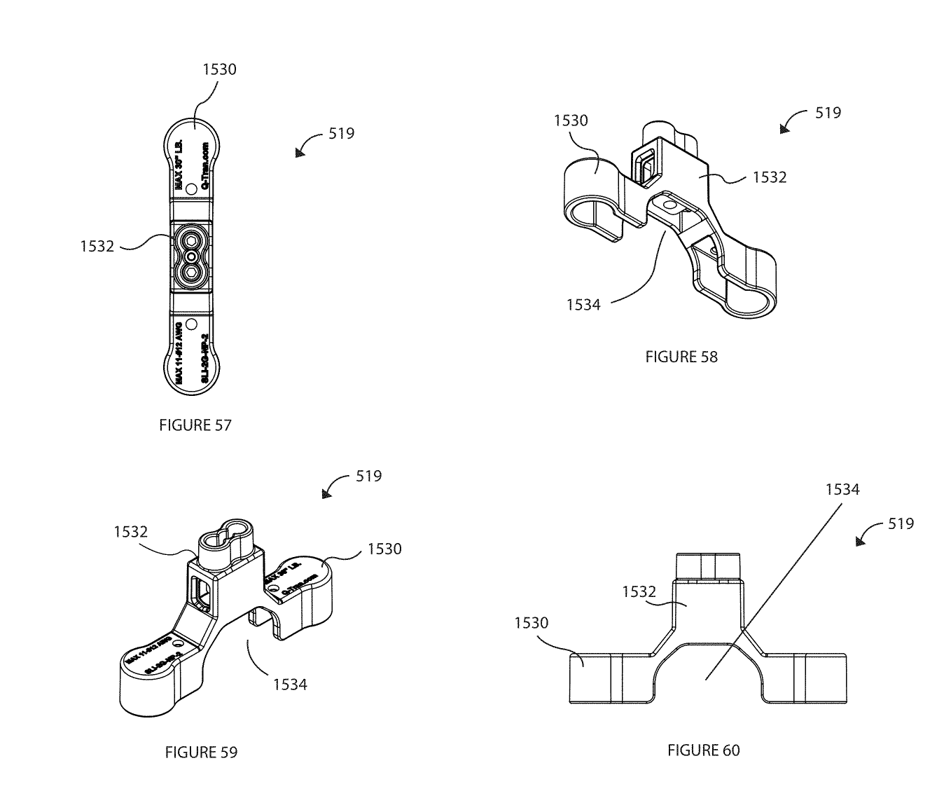

Referring now to FIGS. 30 and 50, the junction box 500 may also include a wire connecting post 519 that can be used as a connecting and/or distribution point for one type of electric wire entering the junction box 500. For example, the wire connecting post 519 provides a connecting and distribution point for the Neutral wire in FIG. 50. The wire connecting post 519 is shown in greater detail in FIGS. 57-60. The wire connecting post 519 may include one or more base supports 1530 that are configured to engage with the housing 502 of the junction box 500. The base support 1530 may be configured to be press-fit into the housing 502 of the junction box 500, and/or the base support 1530 may be secured to the housing 502 by one or more fasteners (not shown). The wire connecting post 519 may also include a terminal block housing 1532 that is dimensioned and configured to receive a suitable terminal block that can be used to facilitate the connections made within the junction box 500. The wire connecting post 519 may also include a thru-arch 1534 that may be positioned so as to permit wires or other connectors to be run throughout the junction box 500.

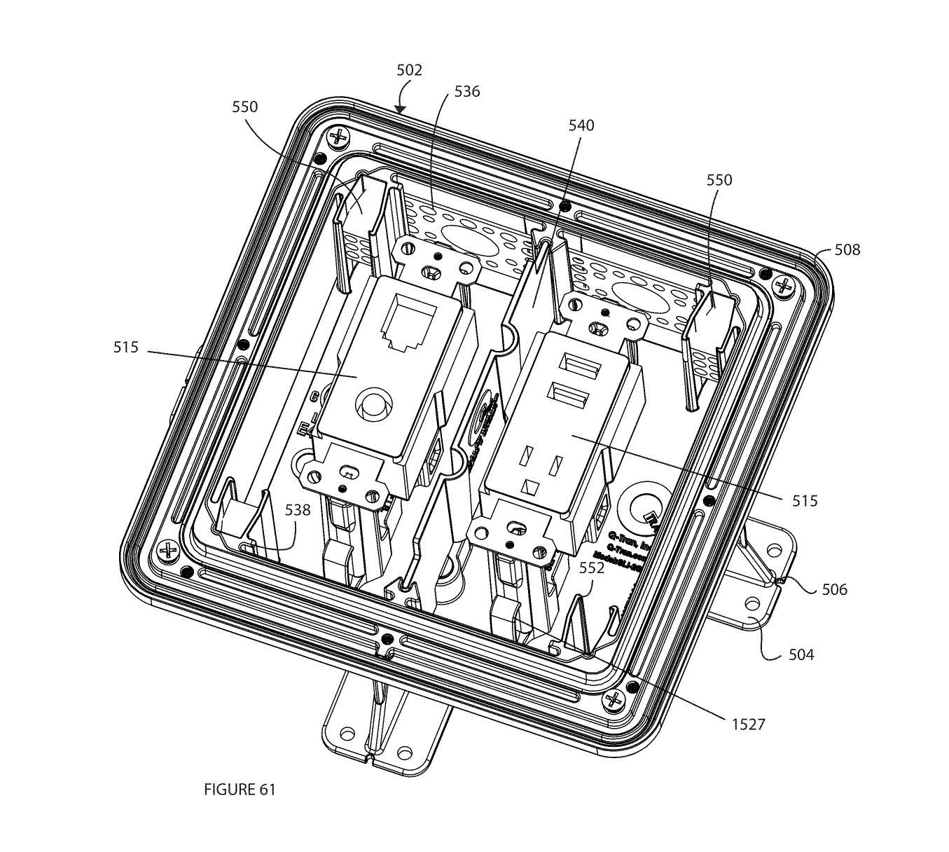

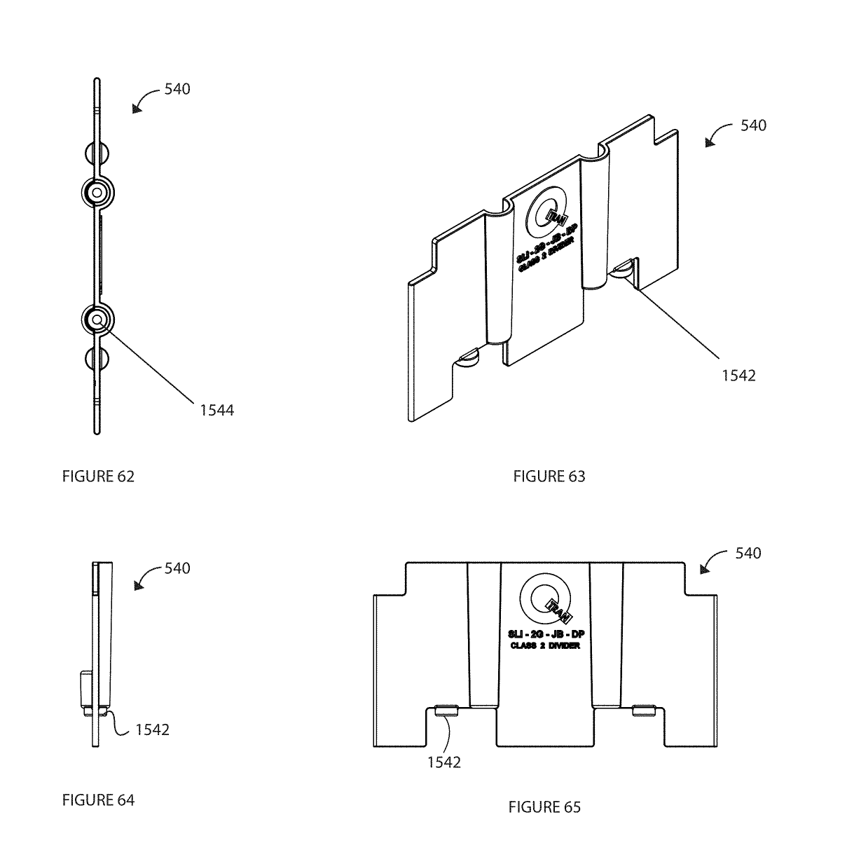

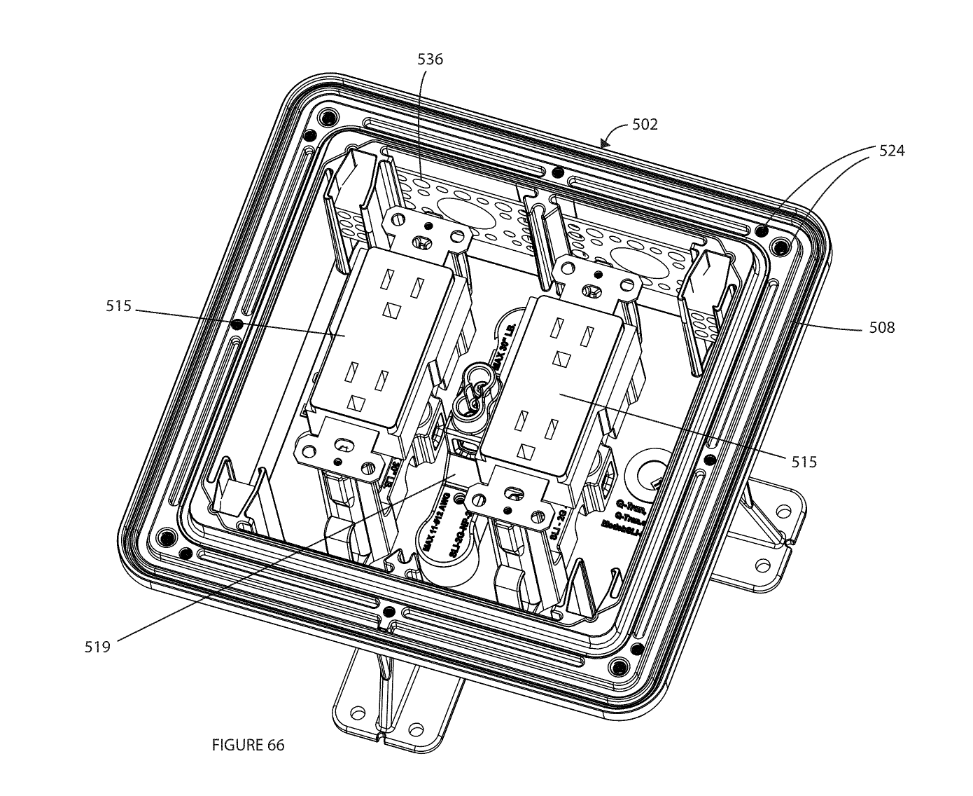

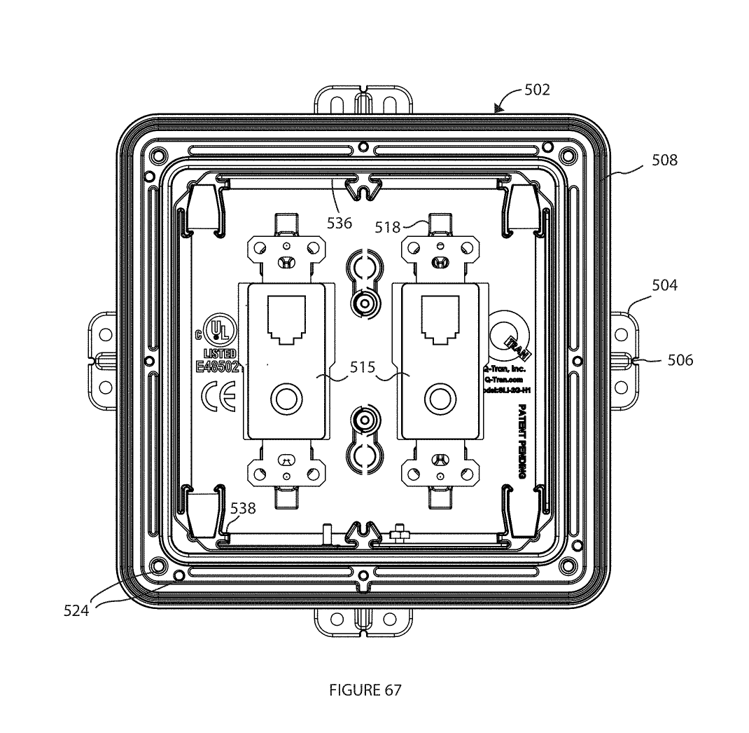

With reference to FIGS. 30 and 61-65, the junction box 500 may also include a divider plate 540 that may be positioned within the housing 502 so as to provide a barrier between a high voltage unit 515 and a lower voltage unit 515. The divider plate 540 may be desirable in order to permit using the junction box 500 for distinct types of electrical uses, such as low voltage data and regular power. The divider plate 540 may preferably be a Class 2 divider plate that is sufficiently rated in order to permit a low voltage compartment and a high voltage compartment to exist within the same junction box 500. The divider plate 540 may include one or more plugs 1542 for insertion into a receiving hole (not shown) of the housing 502 of the junction box 500, and/or one or more fastener mounting holes 1544 that can be used to removably affix the divider plate 540 to the housing 502 by one or more fasteners. It is understood that the divider plate 540 and the wire connecting post 519 may be adapted to be positioned within the same location of the housing 502, so that it is optional whether one or the other is present depending upon the desired purpose of the junction box 500. For example, as shown in FIGS. 50 and 66, when the entire housing 502 acts as a high voltage compartment, due for example to the inclusion of two high voltage units 515, the wire connecting post 519 is affixed to the housing 502 to provide for connection and/or distribution of the high voltage wires entering the junction box 500 to the units 515. Likewise, when the junction box 500 includes multiple types of devices, for example a low voltage unit 515 and a high voltage unit 515, as shown in FIG. 61, then the divider plate 540 may be utilized with the housing 502 to provide for a low voltage compartment and a high voltage compartment. When only low voltage units 515 as positioned within the housing 502 of the junction box 500 both the divider plate 540 and the wire connecting post 519 may preferably be left out of the housing, as shown for example in FIG. 67.

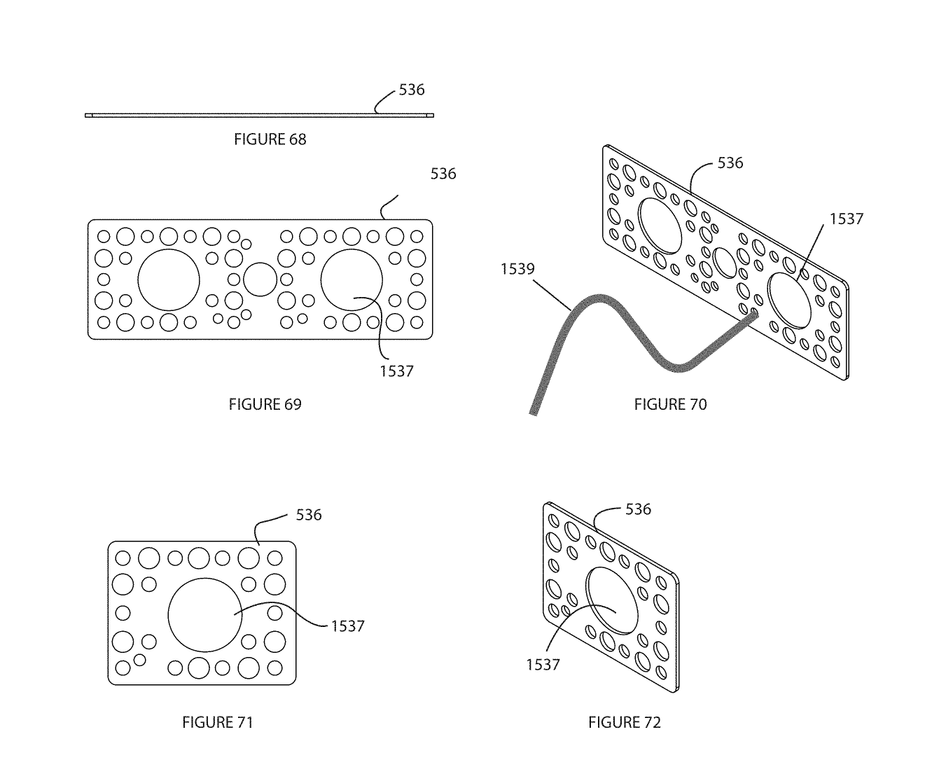

Referring now to FIGS. 30, 50, 61 and 66-72, the junction box 500 may also include a grounding plate 536 that may be installed one or more sides of the housing 502. The grounding plate 536 can be used to both reinforce the sides of the housing 502 when electrical connectors are installed on the junction box 500, and to electrically ground the units 515 to the electrical cables and/or conduit (see e.g. FIG. 50) connected to the junction box 500 by electrically bonding the ground conductor to the grounding plate 536, which is thereby electrically bonded to the cables and/or conduit. The grounding plate 536 may be slid and retained in place on the housing 502 by one or more tabs 538 extending from the housing 502. The grounding plate 536 may vary in size depending as on the side of the housing 502 in which the grounding plate 536 may be installed, and may have a single thru-hole 1537 (FIGS. 71-72) or multiple thru-holes 1537 (FIGS. 69-70) for alignment with the knock-outs 516. The grounding plate 536 may also include a pre-installed wire 1539, for example a wire suitable for a grounding connection to the grounding plate 536.

With reference now to FIGS. 30, 50, 61 and 66, the junction box 500 may also include one or more wire terminal blocks 550 that are configured to provide for snap-in wiring connections to be made between the wiring entering and leaving the junction box 500 and/or the units 515 connected within the junction box 500. The wire terminal blocks 550 may be positioned within retaining channels 552 that are configured to hold and retain one or more wire terminal blocks 550. It is understood that any combination of wire terminal blocks 550 may be used within the junction box 500 depending upon the application and/or use of the junction box 500 or the units 515 that are connected within the junction box 500.

Referring now to FIGS. 30, 37-40 and 50, the installation of the junction box 500 will be discussed. The junction box 500 may be mounted on the wall surface through the use of the one or more mounting tabs 504 and appropriate fasteners (not shown), for example, screws, nails, lag screws, bolts, any combination thereof or the like. Once installed, or even prior to installation, the units 515 may be attached to the mounting posts 518, and the housing cover 510 may then be installed, and the gasket 512 may be fixed between the housing cover 510 and the housing 502. Electrical wires, cables and/or conduit may be connected to the junction box 500, as shown in FIG. 50 for example, by removing one or more of the knock-outs 516 and coupling the wires, cables and/or conduit to the junction box 500 by suitable connectors. In certain applications, a décor panel 130 may be placed around the junction box 500. It is understood that the décor panel 130 may comprise the entire wall or ceiling covering or cover substantial portions of the wall or ceiling. In order to provide a finished look for the installed junction box 500 a snap-in frame 532 may be installed on the junction box 500 and décor panel 130. The snap-in frame 532 may include one or more tabs that engage with corresponding recesses on the housing cover 510 in order to provide for removable affixation of the snap-in frame 532 to the junction box 500.

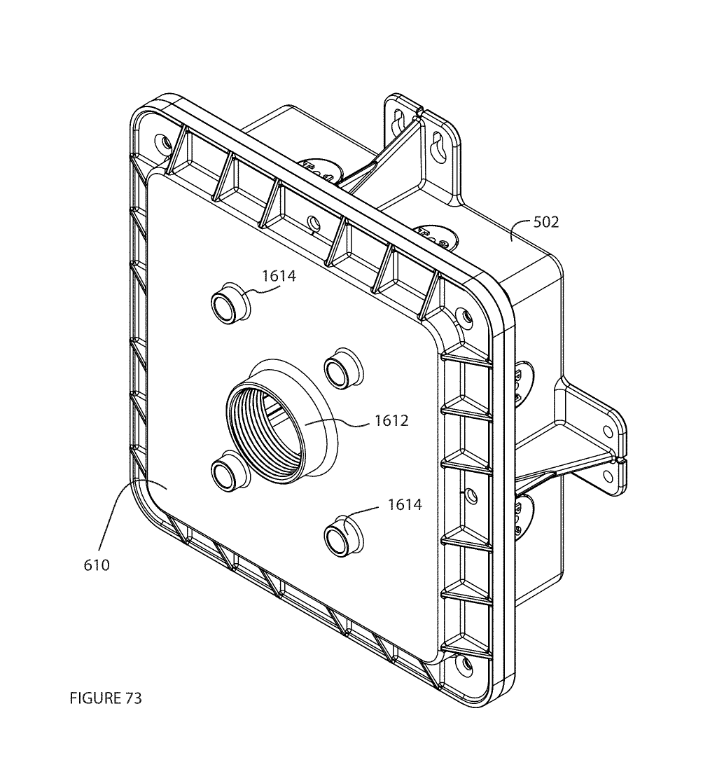

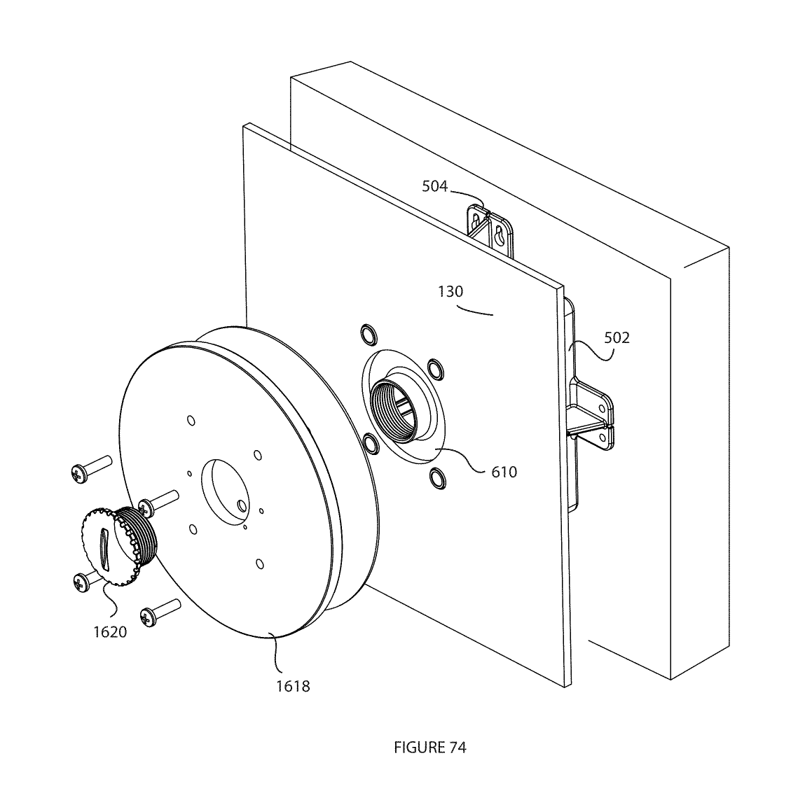

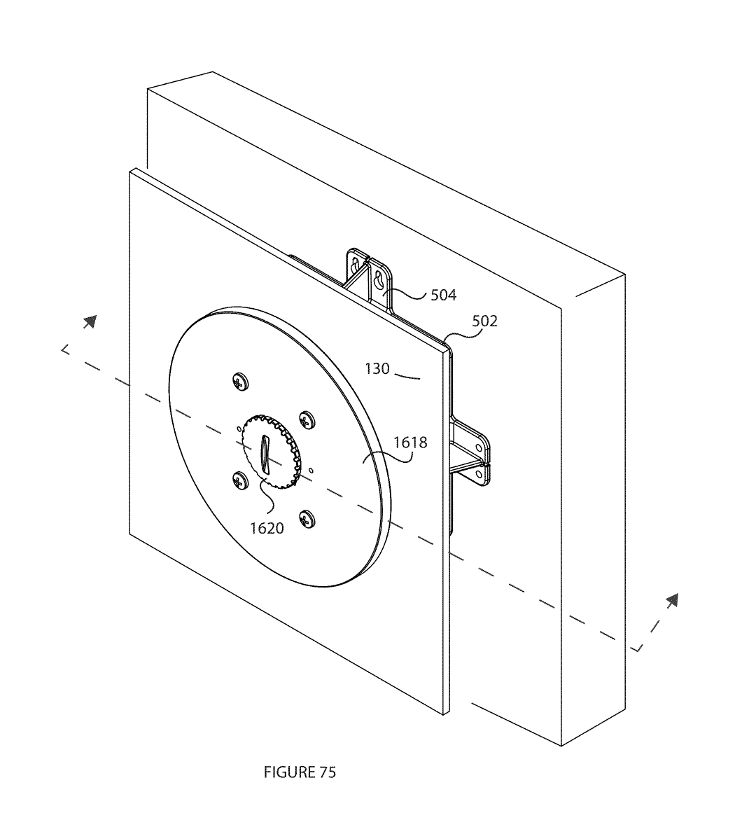

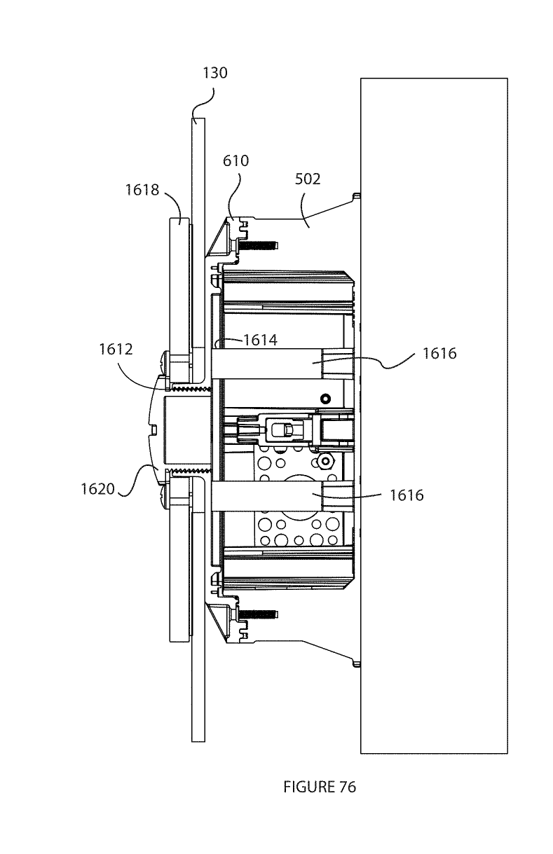

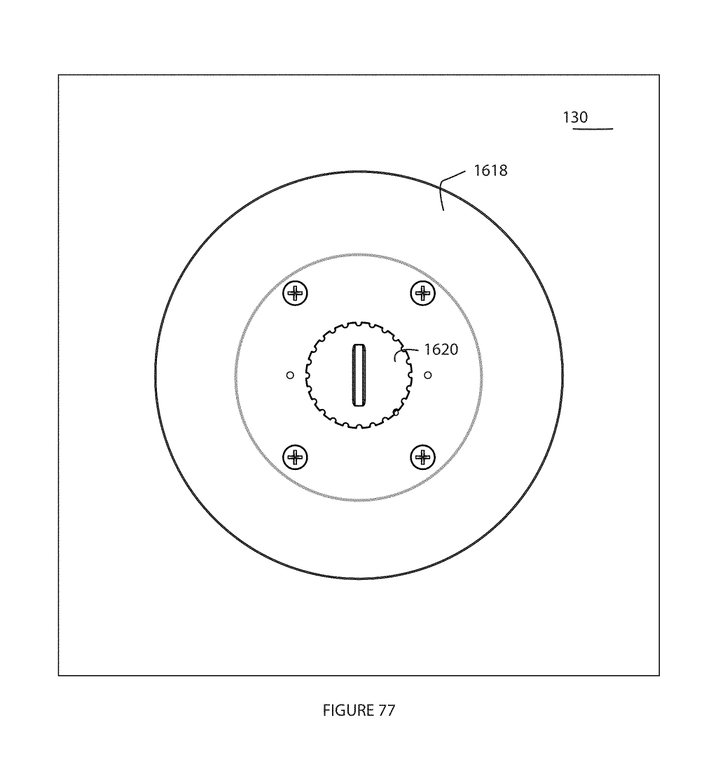

Referring now to FIGS. 30, 42 and 73-77, the junction box 500 may optionally include a sconce housing cover 610 that is configured to allow connection of a wall-mounted or ceiling-mounted sconce lighting unit (not shown) to the junction box 500. The sconce housing cover 610 may include an electrical wiring opening 1612 that is configured to allow electrical wiring (not shown) from the junction box 500 to be connected to the wall-mounted scone lighting unit (not shown). The sconce housing cover may also include one or more mounting holes 1614 that permit one or more sconce mounting posts 1616 to be exposed to allow connection of a sconce mounting plate 1618 to the junction box 500. The sconce mounting posts 1616 may be secured to the housing 502 of the junction box 500 so that any connections made thereto are ultimately secured to the wall or ceiling surface on which the junction box 500 has been installed. The electrical wiring opening 1612 of the sconce housing cover 610 may preferably be threaded to accept a rain cap cover 1620 in order to provide for at least a substantially rain-tight cover for the junction box 500 with the sconce housing cover 610 installed therein prior to final installation of the junction box 500.

It is understood that the junction box 500, and the various components thereof discussed above, may be made from any suitable material for the intended purpose of the junction box 500. For example, the junction box 500, and the various components thereof, may be constructed, in whole or in part, from any suitable plastic, fiberglass and/or metals.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

1. A junction box, comprising:
a housing at least partially enclosing an interior region of the junction box and having a base at least partially enclosing a side of the interior region and a perimeter extending from the base and around the interior region to form an aperture for a side of the interior region opposite the base;
a perimeter flange extending at least partially around the perimeter of the housing;
a housing cover configured for removable attachment to the housing at the perimeter flange; and
at least one device mounting post positioned within the interior region and configured for removable attachment to the base through the aperture.

2. The junction box according to claim 1, wherein the housing cover comprises at least one opening providing access to the interior region of the junction box.

3. The junction box according to claim 2, wherein the device mounting post is configured to provide support and retention of at least one electrical device, and wherein the opening is substantially aligned with the device mounting post to allow the at least one electrical device to be positioned at least partially within the opening.

4. (canceled)

5. The junction box according to claim 1, wherein the device mounting post comprises a base portion configured for press-fit attachment to the housing and a terminal block receptacle configured for receipt and retention of a terminal block.

6. The junction box according to claim 1, wherein the device mounting post comprises a base portion and a pair of stanchions extending from the base portion and configured for receipt of an electrical device.

7. The junction box according to claim 1, wherein the junction box further comprises a sealing gasket positioned between the housing cover and the perimeter flange.

8. The junction box according to claim 1, wherein the junction box further comprises a peripheral flange extending at least partially around the perimeter flange, and wherein the peripheral flange comprises a perimeter channel configured to receive a peripheral gasket.

9. The junction box according to claim 8, wherein the peripheral flange is configured for connection to a removable cover, and the peripheral gasket is configured for positioning between the peripheral flange and the removable cover.

10. The junction box according to claim 1, further comprising at least one mounting tab positioned on an exterior surface of the housing.

11. The junction box according to claim 10, wherein each of the at least one mounting tabs comprises an alignment notch.

12. The junction box according to claim 1, further comprising a wire connecting post positioned within the interior region of the junction box and configured for connection to at least one electrical wire.

13. The junction box according to claim 1, further comprising a divider plate positioned within the interior region of the junction box and configured to divide the interior region of the junction box into at least two separate sections.

14. The junction box according to claim 1, further comprising a grounding plate having at least one thru-hole and positioned within the interior region of the junction box, and at least one knock-out positioned in the housing and substantially aligned with the thru-hole of the grounding plate.

15. The junction box according to claim 1, further comprising at least one retaining channel positioned within the interior region of the junction box and configured for receipt and retention of at least one wire terminal block.

16. The junction box according to claim 13, wherein the at least two separate sections comprise a first section and a second section, wherein the first section is configured for receipt of a high voltage receptacle and the second section is configured for receipt of a low voltage receptacle.

17. The junction box according to claim 12, wherein the at least one electrical wire is pre-wired to the wire connecting post prior to final installation of the junction box.

18. A junction box, comprising:
a housing at least partially enclosing an interior region of the junction box and having a perimeter extending around the interior region;
a perimeter flange extending at least partially around the perimeter of the housing;
a housing cover configured for removable attachment to the housing at the perimeter flange;
at least one device mounting post positioned within the interior region; and
a wire connecting post positioned within the interior region of the junction box and configured for connection to at least one electrical wire.

19. The junction box according to claim 18, wherein the at least one electrical wire is pre-wired to the wire connecting post prior to final installation of the junction box.

20. A junction box, comprising:
a housing at least partially enclosing an interior region of the junction box and having a perimeter extending around the interior region;
a perimeter flange extending at least partially around the perimeter of the housing;
a housing cover configured for removable attachment to the housing at the perimeter flange; and
at least one device mounting post positioned within the interior region, and comprising a base portion configured for press-fit attachment to the housing, and a terminal block receptacle configured for receipt and retention of a terminal block.

21. The junction box according to claim 20, wherein the device mounting post further comprises a pair of stanchions extending from the base portion and configured for receipt of an electrical device.
